(19) United States
(12) Patent Application Publication
(10) Pub. No.: US 2026/0352771 A1
(43) Pub. Date: Nov. 5, 2026

(54) INFORMATION PROCESSING APPARATUS, INFORMATION PROCESSING METHOD, AND NON-TRANSITORY COMPUTER-READABLE STORAGE MEDIUM STORING PROGRAM

(71) Applicant: SEIKO EPSON CORPORATION, TOKYO (JP)

(72) Inventor: Hiroto TSUKIOKA, MATSUMOTO-SHI (JP)

(21) Appl. No.: 19/665,401

(22) Filed: May 1, 2026

(30) Foreign Application Priority Data
May 1, 2025 (JP) 2025-076324

(51) Int. Cl. H04N 1/32; H04L 9/32

(52) U.S. Cl. CPC H04N 1/32096; H04L 9/3213

(57) ABSTRACT

An information processing apparatus is capable of communicating with a first server apparatus configured to acquire scan data and a second server apparatus configured to register the scan data, and the information processing apparatus includes: a first acquisition section configured to acquire, from the first server apparatus, the scan data and identification information of a transmission destination of the scan data in the second server apparatus; a second acquisition section configured to acquire, based on the identification information acquired by the first acquisition section, related information related to the transmission destination of the scan data and a second access token indicating an access right to the second server apparatus; and a transmission section configured to transmit the scan data to the second server apparatus using the second access token based on the related information acquired by the second acquisition section.

The present application is based on, and claims priority from JP Application Serial Number 2025-076324, filed May 1, 2025, the disclosure of which is hereby incorporated by reference herein in its entirety.

### BACKGROUND

### 1. Technical Field

The present disclosure relates to an information processing apparatus, an information processing method, and a non-transitory computer-readable storage medium storing a program.

### 2. Related Art

A technique is known in which scan data scanned by an apparatus having a scan function is transmitted to a second server apparatus via a first server apparatus different from the apparatus.

For example, JP-A-2017-175233 discloses a technique in which an image forming apparatus scans a document, transmits the scan data to a document management server via a print server, and the document management server registers the scan data.

However, in order to transmit the scan data from the first server apparatus to the second server apparatus, it may be necessary to change control content of the first server.

### SUMMARY

According to an aspect of the present disclosure, there is provided an information processing apparatus capable of communicating with a first server apparatus configured to acquire scan data and a second server apparatus configured to register the scan data, the information processing apparatus including: a first acquisition section configured to acquire, from the first server apparatus, the scan data and identification information of a transmission destination of the scan data in the second server apparatus; a second acquisition section configured to acquire, based on the identification information acquired by the first acquisition section, related information related to the transmission destination of the scan data and a second access token indicating an access right to the second server apparatus; and a transmission section configured to transmit the scan data to the second server apparatus using the second access token based on the related information acquired by the second acquisition section.

According to another aspect of the present disclosure, there is provided an information processing method performed by an information processing apparatus capable of communicating with a first server apparatus configured to acquire scan data and a second server apparatus configured to register the scan data, the method including: acquiring, from the first server apparatus, the scan data and identification information of a transmission destination of the scan data in the second server apparatus; acquiring, based on the acquired identification information, related information related to the transmission destination of the scan data and a second access token indicating an access right to the second server apparatus; and transmitting the scan data to the second server apparatus using the second access token based on the acquired related information.

According to still another aspect of the present disclosure, there is provided a non-transitory computer-readable storage medium storing a program executable by an information processing apparatus capable of communicating with a first server apparatus configured to acquire scan data and a second server apparatus configured to register the scan data, the program causing the information processing apparatus to execute: acquiring, from the first server apparatus, the scan data and identification information of a transmission destination of the scan data in the second server apparatus; acquiring, based on the acquired identification information, related information related to the transmission destination of the scan data and a second access token indicating an access right to the second server apparatus; and transmitting the scan data to the second server apparatus using the second access token based on the acquired related information.

### BRIEF DESCRIPTION OF THE DRAWINGS

FIG. 1 is a diagram showing a configuration of an information processing system.

FIG. 2 is a block diagram showing a configuration of a scanner and a terminal apparatus.

FIG. 3 is a block diagram showing a configuration of a print server apparatus and a management server apparatus.

FIG. 4 is a block diagram showing a configuration of a mediation server apparatus and a DB server apparatus.

FIGS. 5A-5C are flowcharts showing an operation of the information processing system.

FIGS. 6A and 6B are flowcharts showing the operation of the information processing system.

FIG. 7 is an explanatory diagram showing a display example of a display section in a terminal apparatus.

FIG. 8 is an explanatory diagram showing a display example of the display section in the terminal apparatus.

FIG. 9 is an explanatory diagram showing a display example of the display section in the terminal apparatus.

FIG. 10 is an explanatory diagram showing a display example of the display section in the terminal apparatus.

FIGS. 11A-11C are flowcharts showing the operation of the information processing system.

FIG. 12 is an explanatory diagram showing a display example of the display section in the terminal apparatus.

FIG. 13 is an explanatory diagram showing a display example of the display section in the terminal apparatus.

FIG. 14 is an explanatory diagram showing a display example of the display section in the terminal apparatus.

FIGS. 15A and 15B are flowcharts showing the operation of the information processing system.

FIGS. 16A and 16B are flowcharts showing the operation of the information processing system.

FIG. 17 is an explanatory diagram showing a display example of the display section in the terminal apparatus.

FIG. 18 is an explanatory diagram showing a display example of the display section in the terminal apparatus.

FIGS. 19A and 19B are flowcharts showing the operation of the information processing system.

### DESCRIPTION OF EMBODIMENTS

### 1. Configuration of Information Processing System

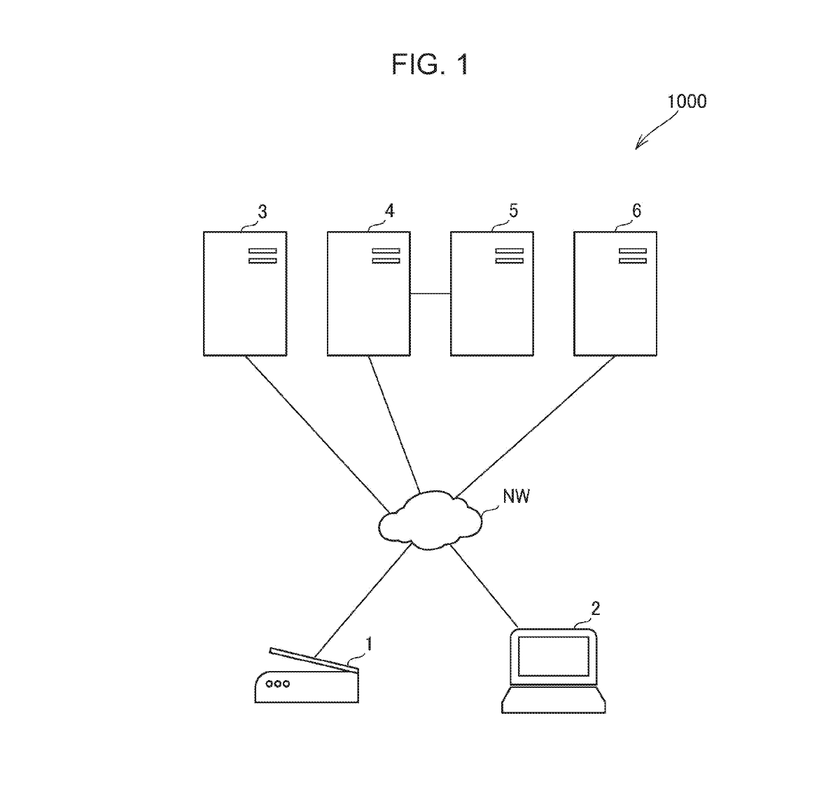

FIG. 1 is a diagram showing a configuration of an information processing system 1000.

The information processing system 1000 is a system that performs various types of information processing related to data management. Specifically, the information processing system 1000 is a system for registering scan data read by a scanner 1 in a management server apparatus 6 and managing the scan data.

As shown in FIG. 1, the information processing system 1000 includes the scanner 1, a terminal apparatus 2, a print server apparatus 3, a mediation server apparatus 4 connected to a database (DB) server apparatus 5, and the management server apparatus 6.

The scanner 1, the terminal apparatus 2, the print server apparatus 3, the mediation server apparatus 4, and the management server apparatus 6 are communicatively connected via a communication network NW. The communication network NW includes the Internet, a telephone network, and other communication networks.

The mediation server apparatus 4 is an example of an "information processing apparatus".

The print server apparatus 3 is an example of a "first server apparatus".

The management server apparatus 6 is an example of a "second server apparatus".

### 2. Configurations of Scanner and Terminal Apparatus

Next, a configuration of each apparatus of the information processing system 1000 will be described.

First, the configurations of the scanner 1 and the terminal apparatus 2 will be described.

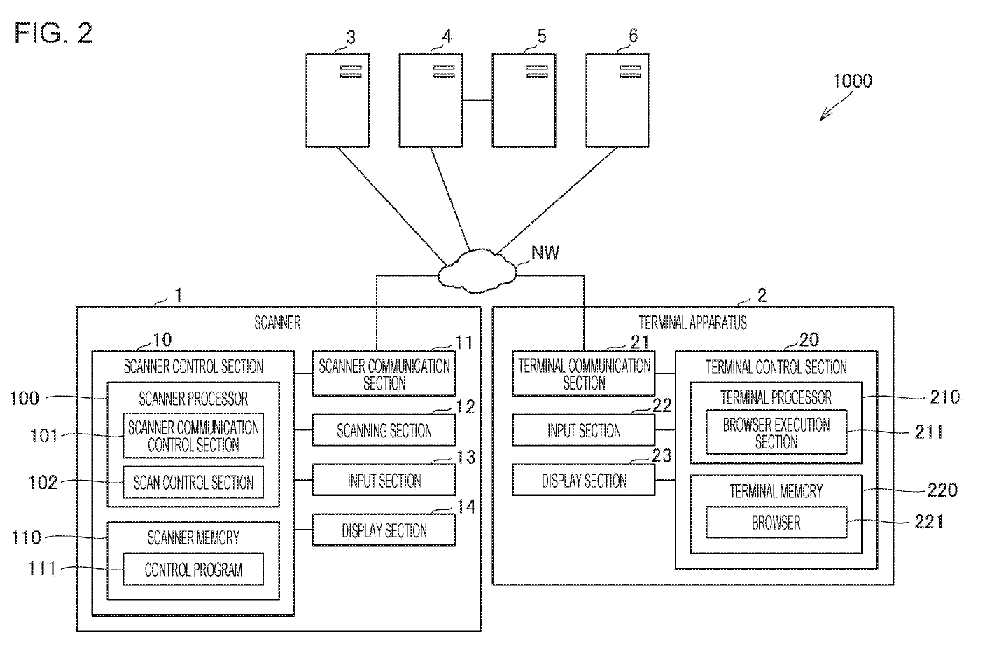

FIG. 2 is a block diagram showing the configurations of the scanner 1 and the terminal apparatus 2.

The scanner 1 includes a scanner control section 10, a scanner communication section 11, a scanning section 12, an input section 13, and a display section 14.

The scanner control section 10 includes a scanner processor 100 which executes a program such as a central processing unit (CPU) or a micro-processing unit (MPU), and a scanner memory 110, and controls each section of the scanner 1.

The scanner memory 110 stores a program executed by the scanner processor 100 and data processed by the scanner processor 100. The scanner memory 110 stores a control program 111 executed by the scanner processor 100 and various other data. The scanner memory 110 has a non-volatile storage area. The scanner memory 110 may have a volatile storage area and constitute a work area of the scanner processor 100. The scanner memory 110 includes, for example, a read-only memory (ROM), a random-access memory (RAM), or the like.

The scanner communication section 11 includes hardware conforming to a predetermined communication standard, such as a communication circuit, and communicates with the print server apparatus 3 under the control of the scanner control section 10.

The scanning section 12 includes components related to reading, including an image sensor and the like. For example, the scanning section 12 irradiates a reading target with light emitted from a light source to read characters and images recorded on the reading target, and outputs image data obtained by the reading to the scanner control section 10. The scanner control section 10 performs data processing such as RGB conversion and compression processing on the image data input from the scanning section 12, and generates data in a predetermined format as reading data.

Hereinafter, the image data obtained by the reading of the scanning section 12 may be referred to as scan data.

The input section 13 includes an input unit, such as an operation switch, a touch panel, a mouse, or a keyboard, provided in the scanner 1, detects an operation performed on the input unit by a user, and outputs a detection result to the scanner control section 10. Based on the input from the input section 13, the scanner control section 10 executes a process corresponding to the operation performed on the input unit.

The display section 14 includes an LED, a display panel, and the like, and executes lighting and blinking of the LED in a predetermined mode, display of information on the display panel, and the like under the control of the scanner control section 10.

The scanner processor 100 functions as a scanner communication control section 101 and a scan control section 102 by reading and executing the control program 111 stored in the scanner memory 110.

The scanner communication control section 101 communicates with the print server apparatus 3 via the scanner communication section 11.

The scan control section 102 controls the scanning section 12 to read characters and images from a reading target and generate reading data.

The terminal apparatus 2 includes a terminal control section 20, a terminal communication section 21, an input section 22, and a display section 23.

The terminal control section 20 includes a terminal processor 210 that executes a program such as a CPU or an MPU, and a terminal memory 220, and controls each section of the terminal apparatus 2.

The terminal memory 220 stores a program executed by the terminal processor 210 and data processed by the terminal processor 210. The terminal memory 220 stores a browser 221 to be executed by the terminal processor 210, and various other data. The terminal memory 220 has a non-volatile storage area. The terminal memory 220 may have a volatile storage area to constitute a work area of the terminal processor 210. The terminal memory 220 is constituted by, for example, a ROM or a RAM.

The terminal communication section 21 includes communication hardware conforming to a predetermined communication standard, and communicates with the mediation server apparatus 4 and the management server apparatus 6 under the control of the terminal control section 20.

The input section 22 includes an input unit, such as an operation switch, a touch panel, a mouse, or a keyboard, provided in the terminal apparatus 2, detects an operation performed on the input unit by a user, and outputs a detection result to the terminal control section 20. Based on the input from the input section 22, the terminal control section 20 executes a process corresponding to the operation performed on the input unit.

The display section 23 includes an LED, a display panel, and the like, and executes lighting and blinking of the LED in a predetermined mode, display of information on the display panel, and the like under the control of the terminal control section 20.

The terminal processor 210 functions as a browser execution section 211 by reading and executing the browser 221 stored in the terminal memory 220. The browser execution section 211 will be described later.

### 3. Configuration of Server Apparatus

Next, the configuration of each server apparatus will be described.

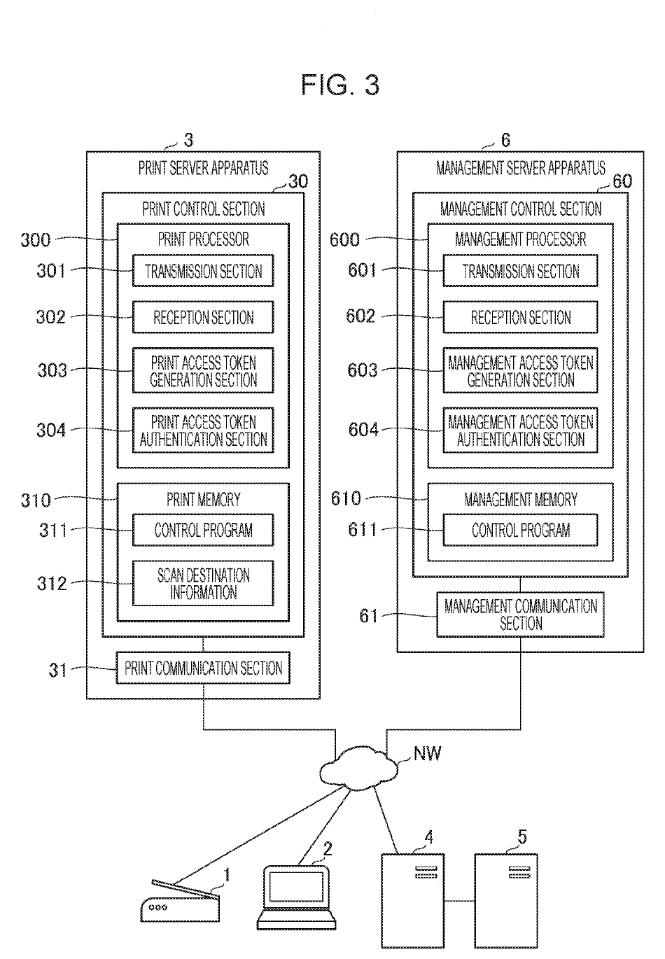

FIG. 3 is a block diagram showing configurations of the print server apparatus 3 and the management server apparatus 6.

The print server apparatus 3 includes a print control section 30 and a print communication section 31.

The print control section 30 includes a print processor 300 that executes a program such as a CPU or an MPU, and a print memory 310, and controls each section of the print server apparatus 3.

The print memory 310 stores a program executed by the print processor 300 and data processed by the print processor 300. The print memory 310 stores a control program 311 to be executed by the print processor 300, and scan destination information 312. The print memory 310 has a non-volatile storage area. The print memory 310 may have a volatile storage area to constitute a work area of the print processor 300. The print memory 310 is constituted by, for example, a ROM, a RAM, or the like.

The scan destination information 312 is information for specifying a transmission destination of scan data in the management server apparatus 6. The scan destination information 312 is indicated by a uniform resource locator (URL) including identification information of the transmission destination of the scan data in the management server apparatus 6.

Hereinafter, the transmission destination of the scan data in the management server apparatus 6 may be referred to as a "scan destination". Hereinafter, the identification information of the scan destination may be referred to as a "destination ID".

The scan destination information 312 is an example of "transmission destination information".

The print communication section 31 includes communication hardware conforming to a predetermined communication standard, and communicates with the scanner 1 and the mediation server apparatus 4 under the control of the print control section 30.

The print processor 300 functions as a transmission section 301, a reception section 302, a print access token generation section 303, and a print access token authentication section 304 by reading and executing the control program 311 stored in the print memory 310.

The transmission section 301 transmits information to the scanner 1 and the mediation server apparatus 4 via the print communication section 31.

The reception section 302 receives the information from the scanner 1 and the mediation server apparatus 4 via the print communication section 31.

The print access token generation section 303 generates a print access token. The print access token is a character string indicating an access right to a URL of an application programming interface (API) for the print server apparatus 3. The API is an interface used when a function of a program is used. That is, the print access token is an access token indicating the access right to the print server apparatus 3.

The print access token is an example of a "first access token".

The print access token authentication section 304 authenticates a print access token.

The management server apparatus 6 includes a management control section 60 and a management communication section 61.

The management control section 60 includes a management processor 600 that executes a program such as a CPU or an MPU, and a management memory 610, and controls each section of the management server apparatus 6.

The management memory 610 stores programs executed by the management processor 600 and data processed by the management processor 600. The management memory 610 stores a control program 611 executed by the management processor 600. The management memory 610 has a non-volatile storage area. The management memory 610 may have a volatile storage area to constitute a work area of the management processor 600. The management memory 610 is constituted by, for example, a ROM or a RAM.

The management communication section 61 includes communication hardware conforming to a predetermined communication standard, and communicates with the terminal apparatus 2 and the mediation server apparatus 4 under the control of the management control section 60.

The management processor 600 functions as a transmission section 601, a reception section 602, a management access token generation section 603, and a management access token authentication section 604 by reading and executing the control program 611 stored in the management memory 610.

The transmission section 601 transmits information to the terminal apparatus 2 and the mediation server apparatus 4 via the management communication section 61.

The reception section 602 receives the information from the terminal apparatus 2 and the mediation server apparatus 4 via the management communication section 61.

The management access token generation section 603 generates a management access token. The management access token is a character string indicating an access right to the URL of the API for the management server apparatus 6. The management access token is an access token indicating the access right to the management server apparatus 6.

The management access token is an example of a "second access token".

The management access token authentication section 604 authenticates a management access token.

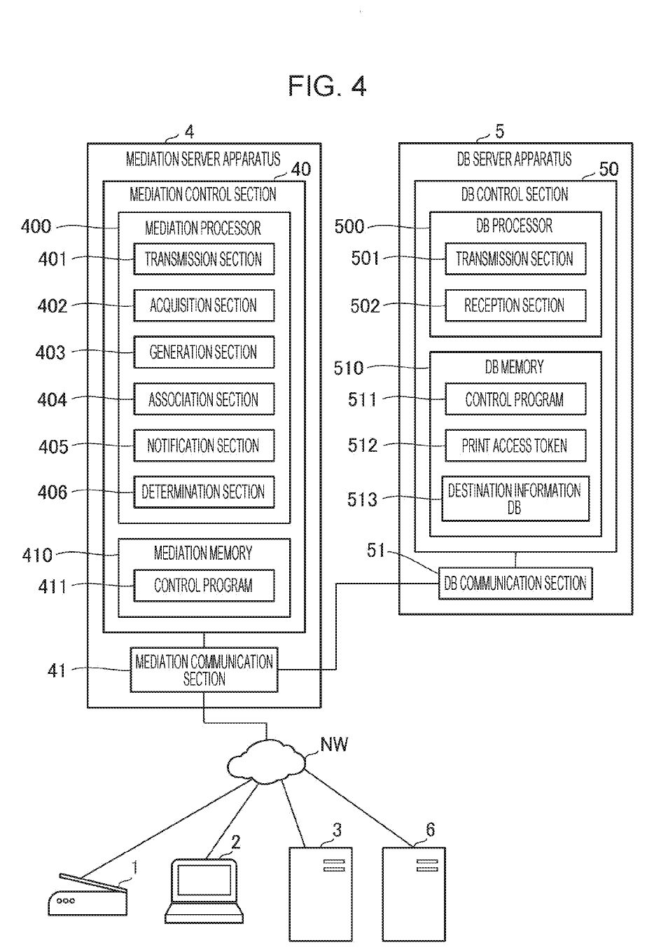

FIG. 4 is a block diagram showing configurations of the mediation server apparatus 4 and the DB server apparatus 5.

First, the configuration of the DB server apparatus 5 will be described.

The DB server apparatus 5 includes a DB control section 50 and a DB communication section 51.

The DB control section 50 includes a DB processor 500 that executes a program such as a CPU or an MPU, and a DB memory 510, and controls each section of the DB server apparatus 5.

The DB memory 510 stores a program executed by the DB processor 500 and data processed by the DB processor 500. The DB memory 510 stores a control program 511 executed by the DB processor 500, a print access token 512, and destination information DB513. The DB memory 510 has a non-volatile storage area. The DB memory 510 may have a volatile storage area to constitute a work area of the DB processor 500. The DB memory 510 is constituted by, for example, a ROM, a RAM, or the like.

The print access token 512 is generated by the print access token generation section 303 and stored in the DB memory 510 in advance.

The destination information DB513 is a database that manages a destination ID, related information, and a management access token in association with each other. The related information is information related to the scan destination and is information associated with the destination ID. The related information includes the name of the storage area of the scan data, region information, and the like.

In the present embodiment, the destination information DB513 is stored in the DB server apparatus 5, but the present disclosure is not limited thereto. For example, the mediation server apparatus 4 may store the destination information DB513. In this case, an association section 404, which will be described later, may associate and register the destination ID, the management access token, and the related information in the destination information DB513 stored in the mediation server apparatus 4. In addition, the association section 404, which will be described later, may edit the scan destination information 312 registered in the destination information DB513 stored in the mediation server apparatus 4. In addition, the association section 404 may be configured to delete the scan destination information 312 registered in the destination information DB513 stored in the mediation server apparatus 4.

The DB communication section 51 includes communication hardware conforming to a predetermined communication standard, and communicates with the mediation server apparatus 4 under the control of the DB control section 50.

The DB processor 500 functions as a transmission section 501 and a reception section 502 by reading and executing the control program 511 stored in the DB memory 510.

The transmission section 501 transmits information to the mediation server apparatus 4 via the DB communication section 51.

The reception section 502 receives the information from the mediation server apparatus 4 via the DB communication section 51.

Next, a configuration of the mediation server apparatus 4 will be described.

The mediation server apparatus 4 includes a mediation control section 40 and a mediation communication section 41.

The mediation control section 40 includes a mediation processor 400 that executes a program such as a CPU or an MPU, and a mediation memory 410, and controls each section of the mediation server apparatus 4.

The mediation memory 410 stores a program executed by the mediation processor 400 and data processed by the mediation processor 400. The mediation memory 410 stores a control program 411 executed by the mediation processor 400. The mediation memory 410 has a non-volatile storage area. The mediation memory 410 may have a volatile storage area to constitute a work area of the mediation processor 400. The mediation memory 410 is constituted by, for example, a ROM, a RAM, or the like.

The mediation communication section 41 includes communication hardware conforming to a predetermined communication standard, and communicates with the terminal apparatus 2, the print server apparatus 3, the DB server apparatus 5, and the management server apparatus 6 under the control of the mediation control section 40.

The mediation processor 400 functions as a transmission section 401, an acquisition section 402, a generation section 403, an association section 404, a notification section 405, and a determination section 406 by reading and executing the control program 411 stored in the mediation memory 410.

The transmission section 401 transmits information to the terminal apparatus 2, the print server apparatus 3, the DB server apparatus 5, and the management server apparatus 6 via the mediation communication section 41.

The acquisition section 402 acquires information from the terminal apparatus 2, the print server apparatus 3, the DB server apparatus 5, and the management server apparatus 6 via the mediation communication section 41.

The generation section 403 generates a destination ID.

The association section 404 associates information.

The notification section 405 performs notification.

The determination section 406 performs various determinations.

Hereinafter, processing of the transmission section 401, the acquisition section 402, the generation section 403, the association section 404, the notification section 405, and the determination section 406 will be described for each case.

### 3-1. Registration of Scan Destination Information

First, processing of each functional section related to the registration of the scan destination information 312 will be described.

The acquisition section 402 acquires the print access token 512. Specifically, the acquisition section 402 acquires the print access token 512 from the DB server apparatus 5.

The acquisition section 402 acquires a management access token from the management server apparatus 6.

The generation section 403 generates a destination ID.

The transmission section 401 transmits a registration instruction to register the scan destination information 312 to the print server apparatus 3 by using the print access token 512.

The association section 404 associates a plurality of pieces of information including the management access token and the destination ID.

Specifically, the association section 404 associates the information by controlling the management access token and the destination ID to be stored in association with each other in the DB server apparatus 5.

### 3-2. Successful Registration of Scan Destination Information

Next, processing of each functional section related to the successful registration of the scan destination information 312 will be described.

The acquisition section 402 acquires registration success information indicating success of registration of the scan destination information 312 from the print server apparatus 3. Specifically, the acquisition section 402 receives a registration completion signal from the print server apparatus 3.

Examples of cases where registration of the scan destination information 312 fails include a case where a communication state is poor, a case where failure or another malfunction occurs in any of the apparatuses, and a case where information entered as new scan destination information 312 has already been used.

The notification section 405 notifies the terminal apparatus 2 that registration of the scan destination information 312 succeeds, based on reception of a registration success signal by the acquisition section 402 and completion of association by the association section 404.

Specifically, the acquisition section 402 receives the registration completion signal from the print server apparatus 3, and transmits the addition completion notification to the terminal apparatus 2 based on the control to store the management access token and the destination ID in association with each other in the DB server apparatus 5. The addition completion notification is a notification indicating that the registration of the scan destination information 312 is successful and completed.

In the following description, "registration" and "addition" have the same meaning.

### 3-3. Editing of Scan Destination Information

Next, the processing of each functional section related to the editing of the scan destination information 312 will be described.

The acquisition section 402 acquires an edit request for editing the scan destination information 312. Specifically, the acquisition section 402 acquires an edit request from the terminal apparatus 2.

The transmission section 401 transmits an instruction to edit the scan destination information 312 to the print server apparatus 3 based on the acquisition of the edit request. Specifically, the transmission section 401 transmits a scan destination edit request to the print server apparatus 3 based on the acquisition of the edit request from the terminal apparatus 2.

The association section 404 can execute edit control of the associated information based on the acquisition of the edit request.

Specifically, the transmission section 401 can transmit the edit request for the scan destination information 312 to the DB server apparatus 5 based on the acquisition of the edit request from the terminal apparatus 2. When the transmission section 401 acquires the edit request from the terminal apparatus 2 but fails to edit the scan destination in the print server apparatus 3, the transmission section 401 does not transmit the edit request for the scan destination information 312 to the DB server apparatus 5. When the transmission section 401 acquires the edit request from the terminal apparatus 2 and succeeds in editing the scan destination in the print server apparatus 3, the transmission section 401 transmits the edit request for the scan destination information 312 to the DB server apparatus 5. The success or failure of the editing of the scan destination in the print server apparatus 3 is specified by receiving a signal indicating the success or failure from the print server apparatus 3.

The acquisition section 402 acquires the print access token 512 based on the acquisition of the edit request.

Specifically, when the edit request is acquired from the terminal apparatus 2, the transmission section 401 requests the print access token 512 from the DB server apparatus 5. Upon receiving the request for the print access token 512, the DB server apparatus 5 transmits the print access token 512 to the terminal apparatus 2. Then, the transmission section 401 acquires the print access token 512 from the DB server apparatus 5.

The transmission section 401 transmits an instruction to edit the scan destination information 312 to the print server apparatus 3 by using the print access token 512 based on the acquisition of the edit request.

Specifically, when the transmission section 401 acquires an edit request from the terminal apparatus 2, the transmission section 401 obtains authentication from the print server apparatus 3 using the print access token 512 acquired from the DB server apparatus 5, and transmits the scan destination edit request to the print server apparatus 3.

The acquisition section 402 acquires edit failure information indicating failure in editing the scan destination information 312 from the print server apparatus 3.

Specifically, the acquisition section 402 receives a scan destination editing success/failure signal indicating success or failure of editing of the scan destination from the print server apparatus 3.

Examples of cases where editing of the scan destination information 312 fails include a case where a communication state is poor, a case where failure or another malfunction occurs in any of the apparatuses, and a case where information entered as the edited scan destination information 312 has already been used.

When the edit failure information is acquired, the association section 404 does not perform the edit control of the associated information.

When the edit failure information is acquired, the notification section 405 notifies the terminal apparatus 2 that editing of the scan destination information 312 fails.

Specifically, in response to the received scan destination editing success/failure signal, the notification section 405 transmits a scan destination editing failure signal indicating that the editing of the scan destination fails to the terminal apparatus 2.

The acquisition section 402 acquires, from the print server apparatus 3, edit success information indicating success in editing the scan destination information 312.

Specifically, the acquisition section 402 receives a scan destination editing success/failure signal indicating success or failure of editing of the scan destination from the print server apparatus 3.

When the edit success information is acquired, the notification section 405 notifies the terminal apparatus 2 that the editing of the scan destination information 312 succeeds.

Specifically, in response to the received scan destination editing success/failure signal, the notification section 405 transmits, to the terminal apparatus 2, an edit completion notification indicating that the editing of the scan destination succeeds.

### 3-4. Deletion of Scan Destination Information

Next, processing of each functional section related to deletion of the scan destination information 312 will be described.

The acquisition section 402 acquires a deletion request for deleting the scan destination information 312. Specifically, the acquisition section 402 acquires a deletion request from the terminal apparatus 2.

The transmission section 401 transmits an instruction to delete the scan destination information 312 to the print server apparatus 3 using the print access token 512 based on the acquisition of the deletion request.

Specifically, when the transmission section 401 acquires a deletion request from the terminal apparatus 2, the transmission section 401 obtains authentication from the print server apparatus 3 using the print access token 512 acquired from the DB server apparatus 5, and transmits the scan destination deletion request to the print server apparatus 3.

The association section 404 can execute deletion control of the associated information based on the acquisition of the deletion request.

Specifically, the transmission section 401 can transmit the deletion request for the scan destination information to the DB server apparatus 5 based on the acquisition of the deletion request from the terminal apparatus 2. When the transmission section 401 acquires the deletion request from the terminal apparatus 2 but fails to delete the scan destination in the print server apparatus 3, the transmission section 401 does not transmit the deletion request for the scan destination information 312 to the DB server apparatus 5. When the transmission section 401 acquires the deletion request from the terminal apparatus 2 and succeeds in deleting the scan destination in the print server apparatus 3, the transmission section 401 transmits the deletion request for the scan destination information 312 to the DB server apparatus 5. The success or failure of the deletion of the scan destination in the print server apparatus 3 is specified by receiving a signal indicating the success or failure from the print server apparatus 3.

The acquisition section 402 acquires deletion failure information indicating failure in deleting the scan destination information 312 from the print server apparatus 3.

Specifically, the acquisition section 402 receives a scan destination deletion success/failure signal indicating success or failure of deletion of the scan destination from the print server apparatus 3.

Note that cases where deletion of the scan destination information 312 fails include, for example, a case where a communication state is poor and a case where a failure or another malfunction occurs in any of the apparatuses.

When the deletion failure information is acquired, the association section 404 does not perform the deletion control of the associated information.

When the deletion failure information is acquired, the notification section 405 notifies the terminal apparatus 2 that the deletion of the scan destination information 312 fails.

Specifically, in response to the received scan destination deletion success/failure signal, the notification section 405 transmits a scan destination deletion failure signal indicating that the deletion of the scan destination fails to the terminal apparatus 2.

The acquisition section 402 acquires deletion success information indicating success in deleting the scan destination information 312 from the print server apparatus 3.

Specifically, the acquisition section 402 receives a scan destination deletion success/failure signal indicating success or failure of deletion of the scan destination from the print server apparatus 3.

When the deletion success information is acquired, the notification section 405 notifies the terminal apparatus 2 that the deletion of the scan destination information 312 succeeds.

Specifically, in response to the received scan destination deletion success/failure signal, the notification section 405 transmits a scan destination deletion success notification indicating the success of the deletion of the scan destination to the terminal apparatus 2.

When the deletion request is acquired, the transmission section 401 transmits an instruction to invalidate the management access token to the management server apparatus 6.

Specifically, the transmission section 401 transmits an invalidation request of the management access token corresponding to the scan destination to be deleted to the management server apparatus 6.

### 3-5. Registration of Scan Data

Next, processing of each functional section related to registration of scan data will be described.

The acquisition section 402 acquires scan data and a destination ID from the print server apparatus 3.

Specifically, the acquisition section 402 acquires the scan data and the scan destination information 312 from the print server apparatus 3, and extracts the destination ID from the URL as the scan destination information 312.

The acquisition section 402 acquires the related information related to the transmission destination of the scan data and the management access token based on the destination ID acquired by the acquisition section 402.

Specifically, the acquisition section 402 acquires the related information and the management access token corresponding to the destination ID included in the scan destination information 312 from the DB server apparatus 5.

The transmission section 401 transmits the scan data to the management server apparatus 6 using the management access token based on the related information acquired by the acquisition section 402. Specifically, the transmission section 401 obtains authentication from the management server apparatus 6 using the management access token, and transmits the scan data.

The acquisition section 402 acquires a registration completion notification indicating that the registration of the scan data is completed from the management server apparatus 6.

The transmission section 401 transmits the registration completion notification to the print server apparatus 3.

A determination section 406 determines a data capacity of the scan data.

When the data capacity determined by the determination section 406 is equal to or greater than a predetermined value, the transmission section 401 transmits an error notification to the management server apparatus 6.

The acquisition section 402 is an example of a "first acquisition section", a "second acquisition section", and a "third acquisition section". The acquisition section 402 is an example of a "registration success information acquisition section", an "edit request acquisition section", an "edit failure information acquisition section", an "edit success information acquisition section", a "deletion request acquisition section", a "deletion failure information acquisition section", and a "deletion success information acquisition section".

The notification section 405 is an example of a "registration success notification section", an "edit failure notification section", an "edit success notification section", a "deletion failure notification section", and a "deletion success notification section".

The transmission section 401 is an example of an "invalidation instruction transmission section", a "registration completion notification transmission section", and an "error notification transmission section".

### 4. Operation

Next, an operation of the information processing system 1000 will be described.

First, the operation of the information processing system 1000 in destination addition processing for registering the scan destination information 312 in the print server apparatus 3 will be described.

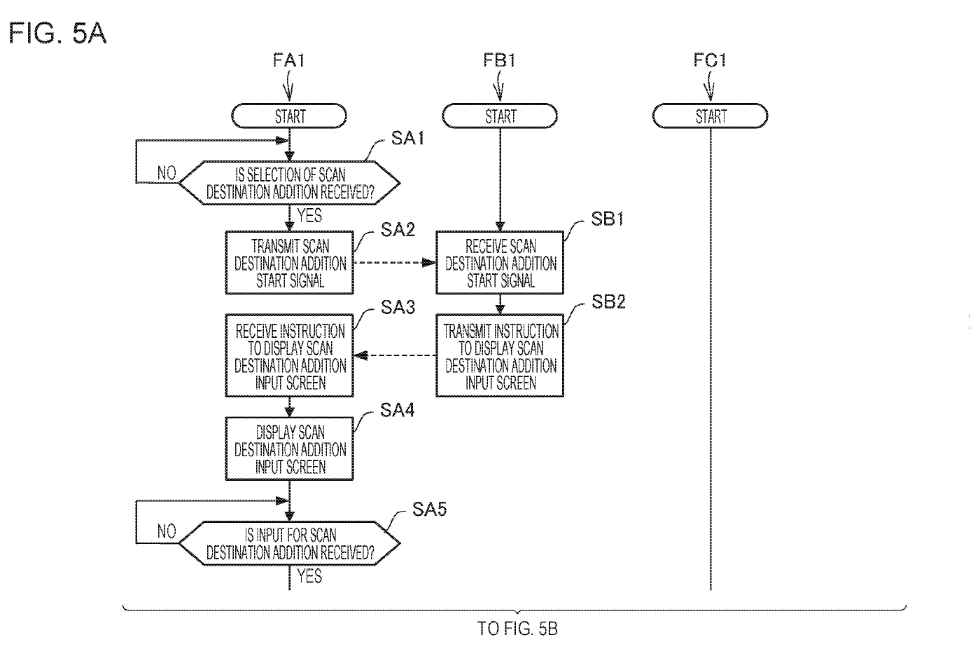

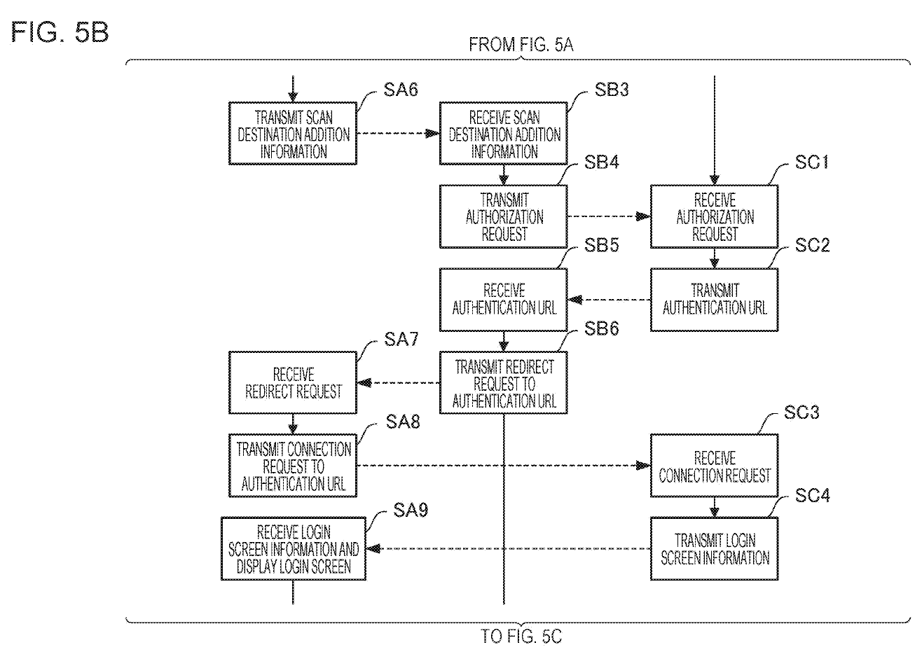

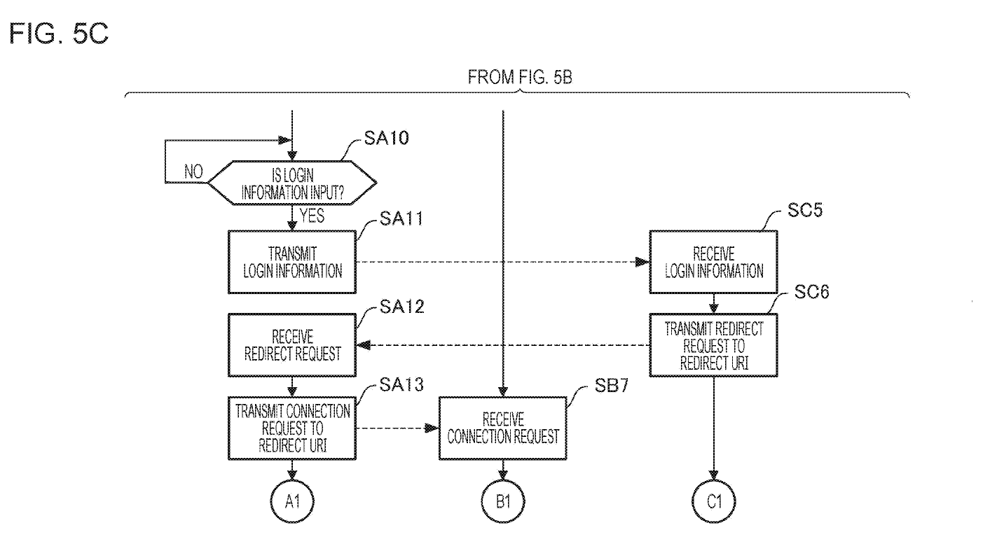

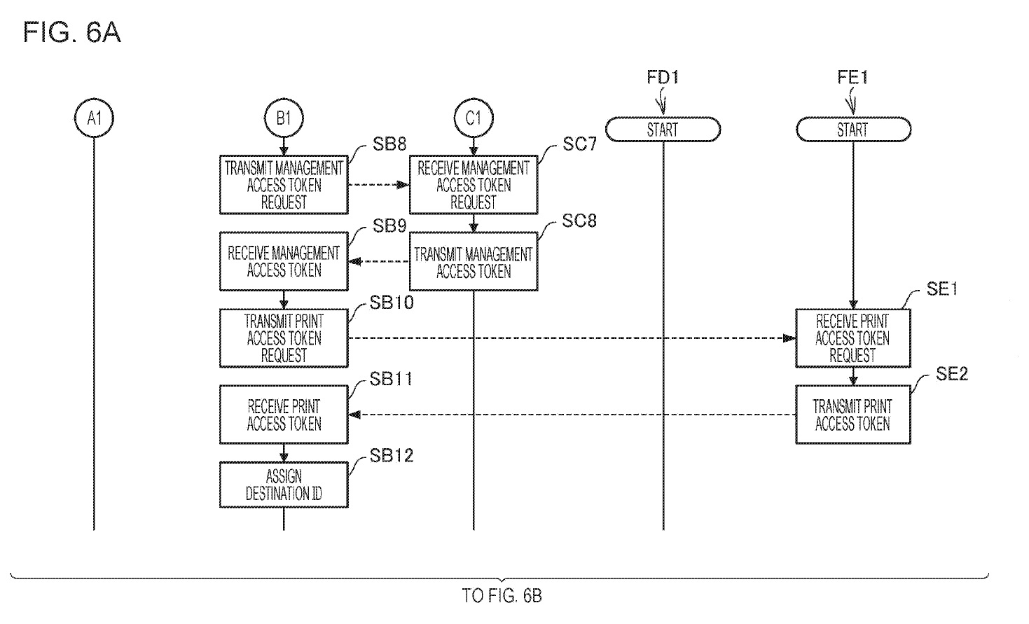

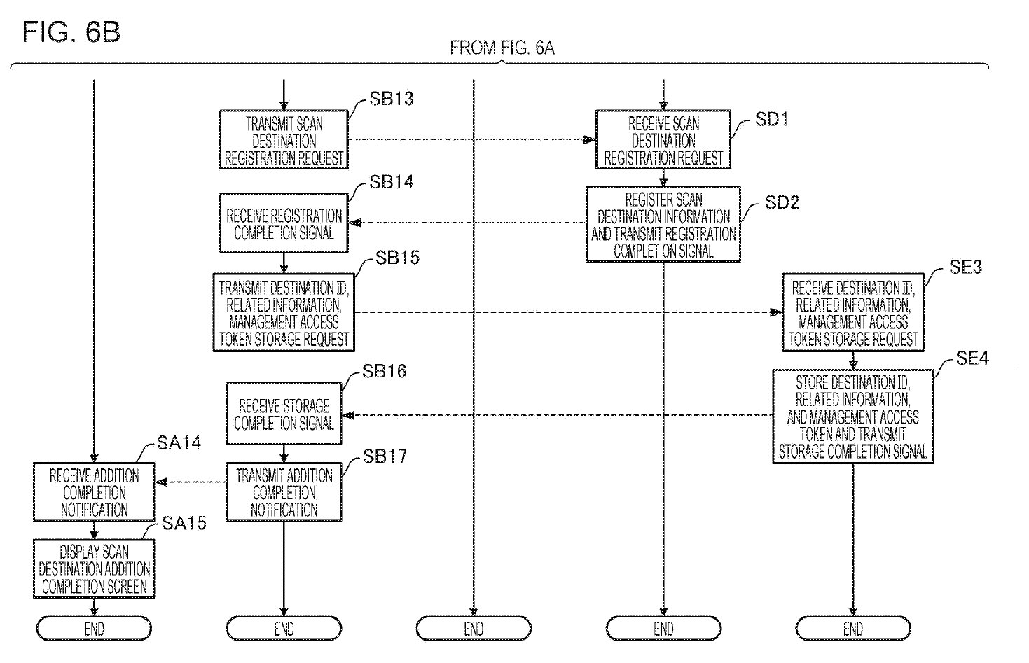

FIGS. 5A-5C, 6A and 6B, are flowcharts showing the operation of the information processing system 1000 in the destination addition processing. In FIGS. 5A-5C, 6A, and 6B, a flowchart FA1 shows the operation of the terminal apparatus 2, and a flowchart FB1 shows the operation of the mediation server apparatus 4. In addition, a flowchart FC1 shows the operation of the management server apparatus 6, a flowchart FD1 shows the operation of the print server apparatus 3, and a flowchart FE1 shows the operation of the DB server apparatus 5.

As shown in FIG. 5A, the browser execution section 211 determines whether a registration instruction to newly register a scan destination is input (step SA1). If the registration instruction is not input, the browser execution section 211 remains in a standby state until the registration instruction is input. When another instruction is received during the standby state, the information processing system 1000 ends the destination addition processing and performs processing according to the received instruction.

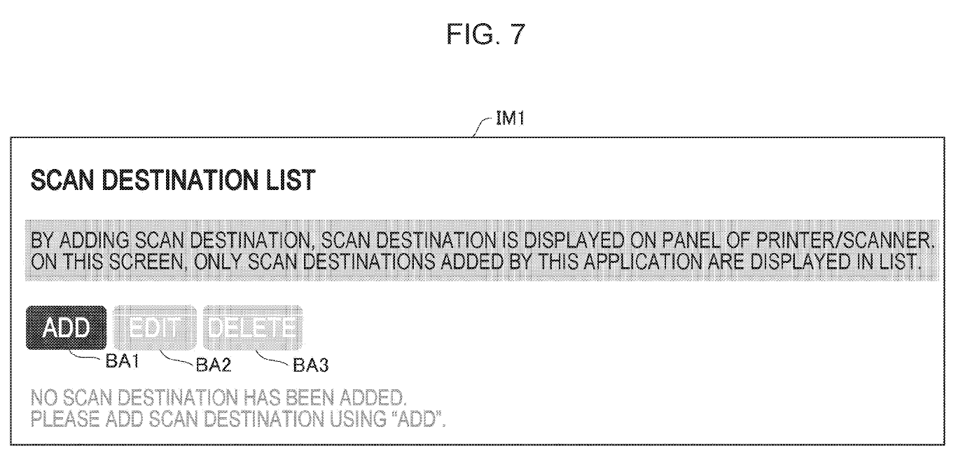

FIG. 7 is an explanatory diagram showing a display example of the display section 23 in the terminal apparatus 2. In a menu image IM1 regarding the scan destination shown in FIG. 7, an add button BA1, an edit button BA2, and a delete button BA3 are displayed.

When the input section 22 is operated by a user and the add button BA1 is selected, the browser execution section 211 determines that the registration instruction is input.

When the input section 22 is operated by the user and the edit button BA2 is selected, the browser execution section 211 determines that an edit instruction is input. The edit instruction is an instruction to edit a scan destination registered in the management server apparatus 6.

When the input section 22 is operated by the user and the delete button BA3 is selected, the browser execution section 211 determines that a deletion instruction is input. The deletion instruction is an instruction to delete a scan destination registered in the management server apparatus 6.

When the registration instruction is input, the browser execution section 211 transmits a scan destination addition start signal indicating that the registration instruction is input to the mediation server apparatus 4 (step SA2). The mediation processor 400 of the mediation server apparatus 4 receives the scan destination addition start signal (step SB1), and transmits an instruction to display a scan destination addition input screen to the terminal apparatus 2 (step SB2). The browser execution section 211 receives the instruction to display the scan destination addition input screen (step SA3). Then, the browser execution section 211 displays the scan destination addition input screen (step SA4).

Thereafter, the browser execution section 211 determines whether an input for scan destination addition is received (step SA5), and when the input is not received, remains in a standby state until the input is received. When the input for the scan destination addition is received, the browser execution section 211 transmits the input scan destination addition information to the mediation server apparatus 4 (step SA6).

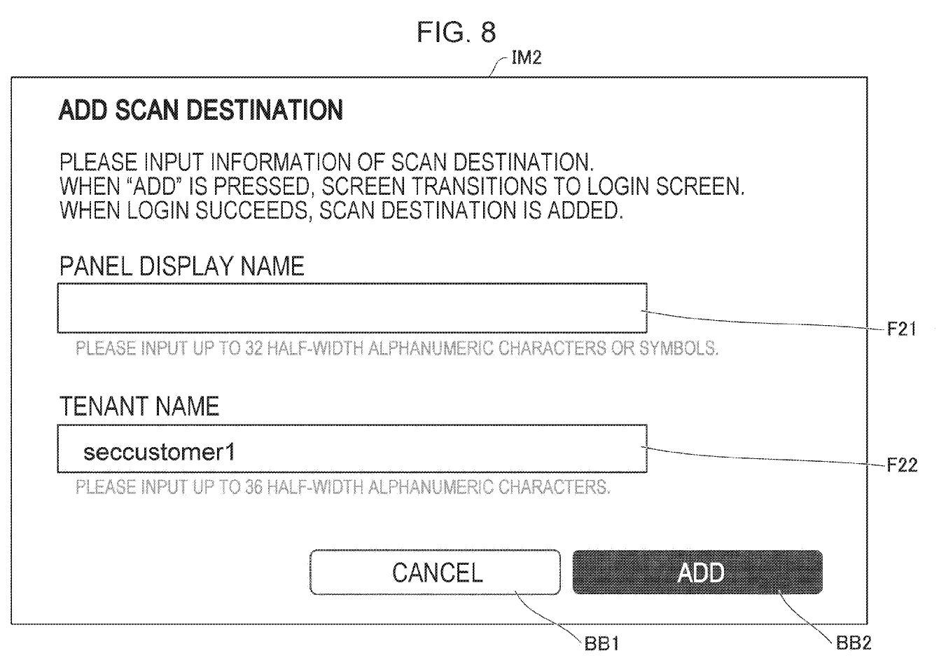

FIG. 8 is an explanatory diagram showing a display example of the display section 23 in the terminal apparatus 2. In a scan destination addition input screen IM2 shown in FIG. 8, a panel display name entry field F21, a tenant name entry field F22, a cancel button BB1, and an add button BB2 are displayed. The panel display name entry field F21 is an entry field of a panel display name which is a character string displayed when the scan destination is displayed on the display section 14 of the scanner 1. The tenant name entry field F22 is an entry field for the name of the storage area of the scan destination. Here, the "tenant name" may be represented by the name "organization name".

When the panel display name entry field F21 and the tenant name entry field F22 are filled in and the add button BB2 is operated, the browser execution section 211 determines that the input for the scan destination addition is received.

The mediation processor 400 of the mediation server apparatus 4 receives the additional information of the scan destination (step SB3), and transmits an authorization request to the management server apparatus 6 (step SB4). The management processor 600 of the management server apparatus 6 receives the authorization request (step SC1), and transmits an authentication uniform resource locator (URL) to the mediation server apparatus 4 (step SC2). The mediation processor 400 of the mediation server apparatus 4 receives the authentication URL (step SB5), and transmits a redirect request to the received authentication URL to the terminal apparatus 2 (step SB6).

The browser execution section 211 receives the redirect request (step SA7), and transmits a connection request for the authentication URL included in the received redirect request to the management server apparatus 6 (step SA8). The management processor 600 of the management server apparatus 6 receives the connection request for the authentication URL (step SC3), and transmits login screen information to the terminal apparatus 2 (step SC4). The browser execution section 211 receives the login screen information and displays a login screen (step SA9). Then, the terminal processor 210 determines whether an input of login information is received (step SA10). When the input of the login information is not received, a standby state is maintained until the input is received.

When the input of the login information is received, the browser execution section 211 transmits the input login information to the management server apparatus 6 (step SA11). The management processor 600 of the management server apparatus 6 receives the login information (step SC5), and transmits a redirect request to a redirect uniform resource identifier (URI) to the terminal apparatus 2 (step SC6). The browser execution section 211 receives the redirect request (step SA12), and transmits a connection request for the authentication URI included in the received redirect request to the mediation server apparatus 4 (step SA13).

The mediation processor 400 of the mediation server apparatus 4 receives the connection request (step SB7), and transmits a request for the management access token to the management server apparatus 6 (step SB8). The management processor 600 of the management server apparatus 6 receives the request for the management access token (step SC7), and transmits the management access token to the mediation server apparatus 4 (step SC8). The mediation processor 400 of the mediation server apparatus 4 receives the management access token (step SB9), and transmits a request for the print access token 512 to the DB server apparatus 5 (step SB10).

The DB processor 500 of the DB server apparatus 5 receives the request for the print access token 512 (step SE1), and transmits the print access token 512 to the mediation server apparatus 4 (step SE2). The mediation processor 400 of the mediation server apparatus 4 receives the print access token 512 (step SB11) and assigns a destination ID (step SB12).

The mediation processor 400 transmits a scan destination registration request to the print server apparatus 3 by using the print access token 512 (step SB13). The registration request transmitted here includes the assigned destination ID. The print processor 300 of the print server apparatus 3 receives the scan destination registration request (step SD1). The print processor 300 registers the scan destination information 312, and transmits a registration completion signal indicating that the registration of the scan destination information 312 is completed to the mediation server apparatus 4 (step SD2).

The mediation processor 400 of the mediation server apparatus 4 receives the registration completion signal (step SB14), and transmits a storage request for the destination ID, the related information, and the management access token to the DB server apparatus 5 (step SB15). The DB processor 500 of the DB server apparatus 5 receives the storage request (step SE3).

The DB processor 500 of the DB server apparatus 5 stores the destination ID, the related information, and the management access token in association with each other in the destination information DB513, and transmits a storage completion signal indicating that the destination ID, the related information, and the management access token are stored to the mediation server apparatus 4 (step SE4). The mediation processor 400 of the mediation server apparatus 4 receives the storage completion signal (step SB16), and transmits an addition completion notification to the terminal apparatus 2 (step SB17).

The browser execution section 211 receives the addition completion notification (step SA14). Then, the browser execution section 211 displays a scan destination addition completion screen indicating that the addition of the scan destination is completed (step SA15). The information processing system 1000 ends the destination addition processing.

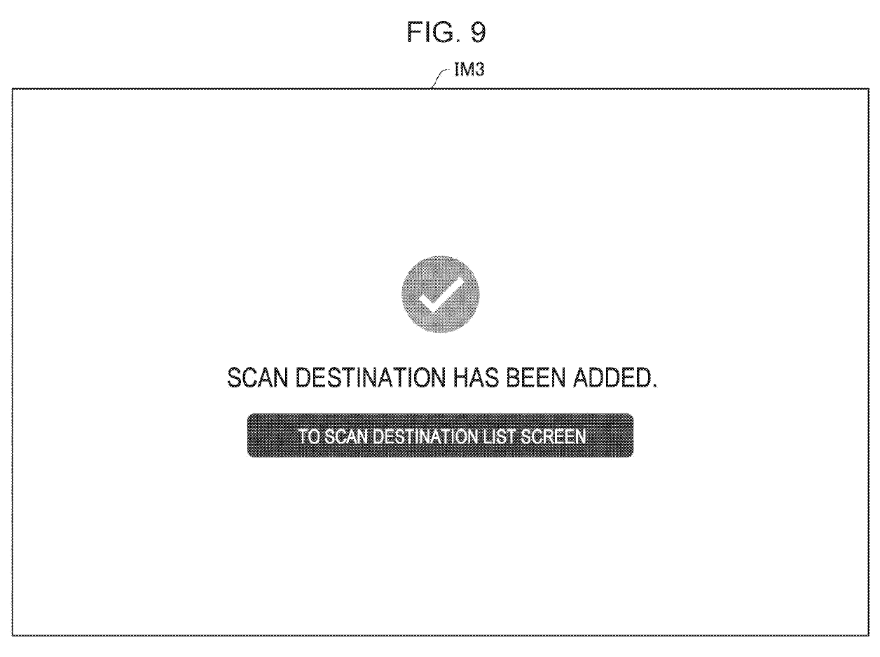

FIG. 9 is an explanatory diagram showing a display example of the display section 23 in the terminal apparatus 2. FIG. 9 shows a display example of a scan destination addition completion screen IM3. In step SA14, a scan destination addition completion screen IM3 as shown in FIG. 9 is displayed on the display section 23.

When the registration of the new scan destination fails, a scan destination addition failure screen indicating that the addition of the scan destination fails may be displayed.

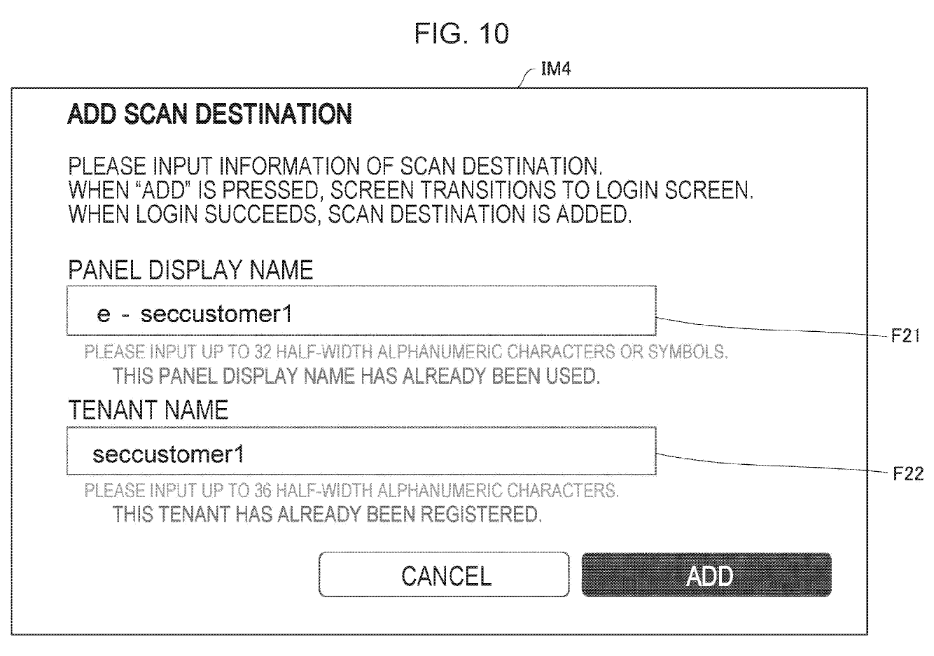

FIG. 10 is an explanatory diagram showing a display example of the display section 23 in the terminal apparatus 2. FIG. 10 shows a display example of a scan destination addition failure screen IM4. A scan destination addition failure screen IM4 as shown in FIG. 10 may be displayed on the display section 23. Here, an example is shown in which registration of a scan destination fails due to input of a character string that has already been used in the panel display name entry field F21 and the tenant name entry field F22.

Step SB13 is performed by the transmission section 401 of the mediation processor 400.

Steps SB9, SB11, and SB16 are performed by the acquisition section 402 of the mediation processor 400.

Step SB12 is performed by the generation section 403 of the mediation processor 400.

Step SB15 is performed by the association section 404 of the mediation processor 400.

Step SB17 is performed by the notification section 405 of the mediation processor 400.

Next, an operation of the information processing system 1000 in destination editing processing for editing the scan destination information 312 registered in the print server apparatus 3 will be described.

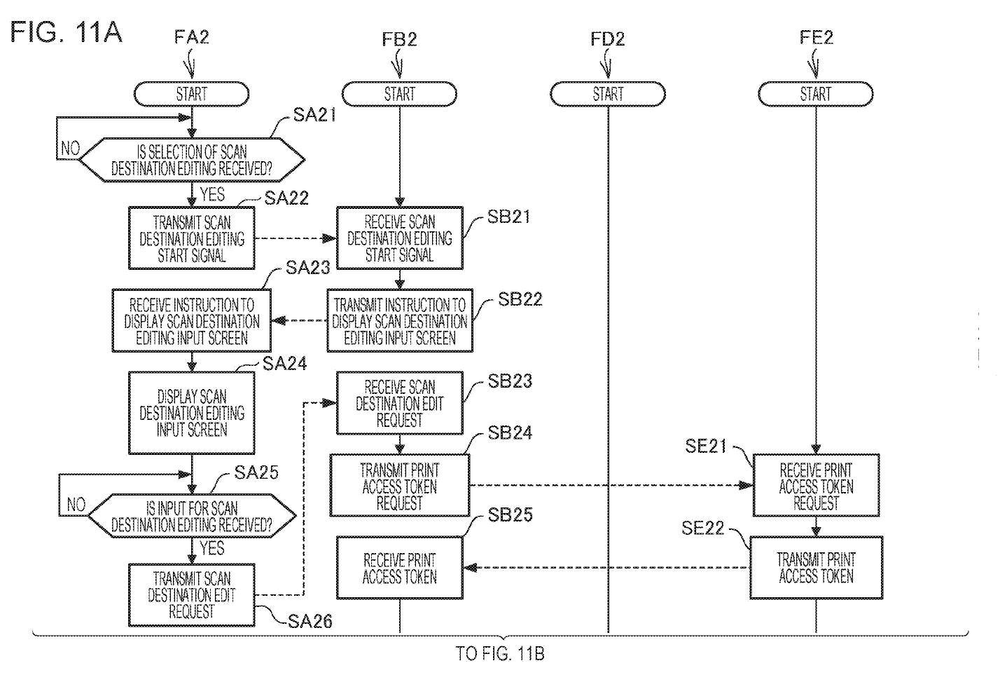

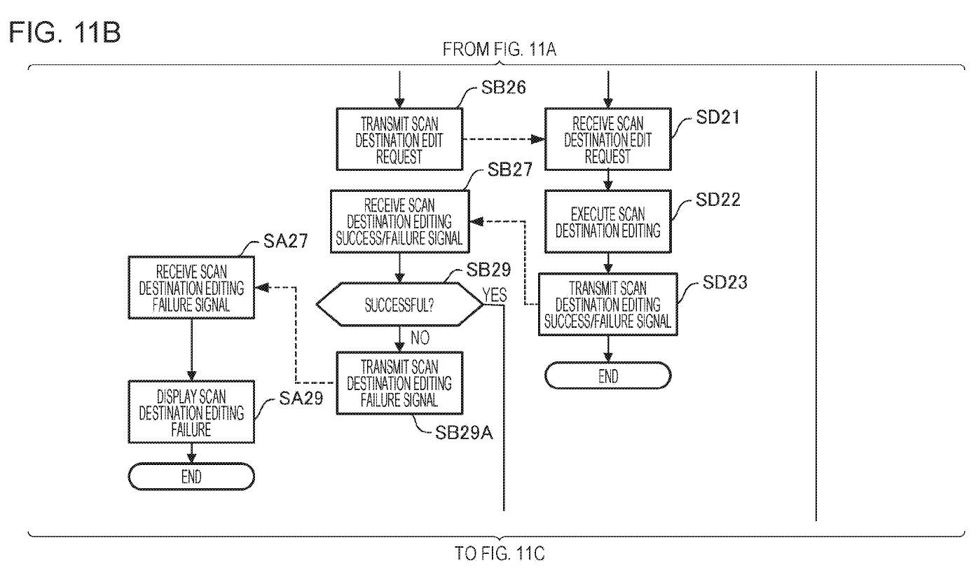

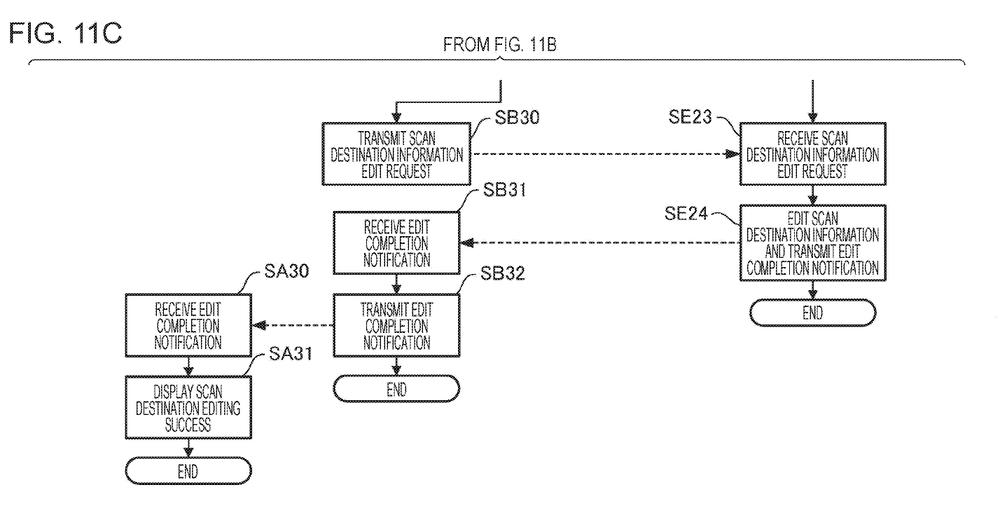

FIGS. 11A-11C are flowcharts showing the operation of the information processing system 1000 in the destination editing processing. In FIGS. 11A-11C, a flowchart FA2 shows the operation of the terminal apparatus 2, and a flowchart FB2 shows the operation of the mediation server apparatus 4. A flowchart FD2 shows the operation of the print server apparatus 3, and a flowchart FE2 shows the operation of the DB server apparatus 5.

As shown in FIG. 11A, the browser execution section 211 determines whether an edit instruction to edit the scan destination registered in the management server apparatus 6 is input (step SA21). If the edit instruction is not input, the browser execution section 211 remains in a standby state until the edit instruction is input. When the information processing system 1000 receives another instruction during the standby state, the information processing system 1000 ends the destination editing processing and performs processing according to the received instruction.

When the edit instruction is input, the browser execution section 211 transmits a scan destination editing start signal indicating that the edit instruction is input to the mediation server apparatus 4 (step SA22). The mediation processor 400 of the mediation server apparatus 4 receives the scan destination editing start signal (step SB21), and transmits an instruction to display a scan destination editing input screen to the terminal apparatus 2 (step SB22). The browser execution section 211 receives the instruction to display the scan destination editing input screen (step SA23). The browser execution section 211 displays the scan destination editing input screen (step SA24).

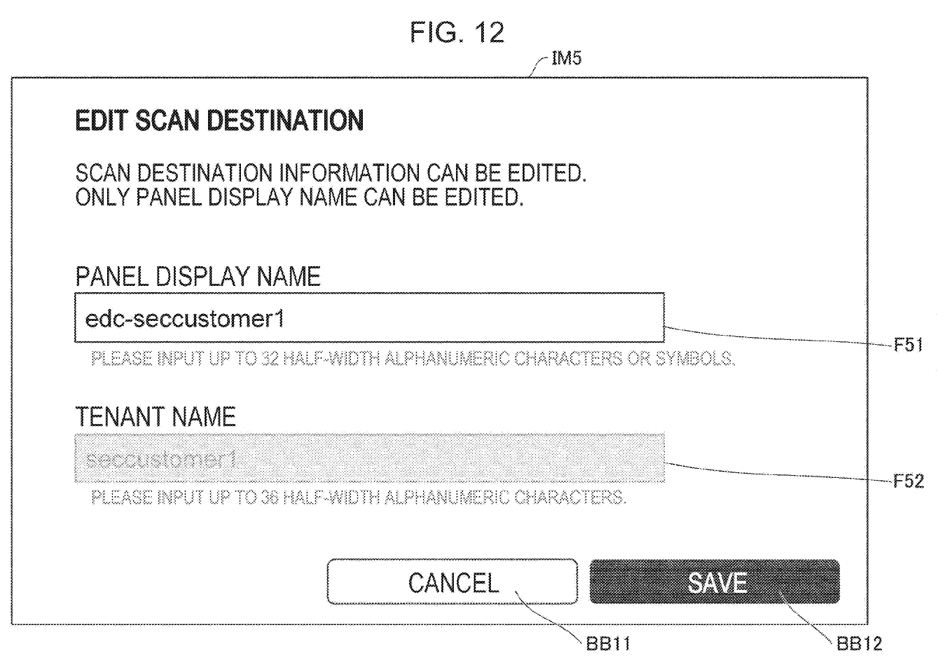

FIG. 12 is an explanatory diagram showing a display example of the display section 23 in the terminal apparatus 2. A display image IM5 shown in FIG. 12 is a display image of the scan destination editing input screen displayed in step SA24. In the display image IM5, a panel display name entry field F51, a tenant name entry field F52, a cancel button BB11, and a save button BB12 are displayed. The panel display name entry field F51 is displayed as changeable, whereas the tenant name entry field F52 is displayed as unchangeable. That is, as the editing of the transmission destination of the scan data in the management server apparatus 6, the tenant name which is the transmission destination of the scan data in the management server apparatus 6 cannot be changed. On the other hand, the panel display name in the display section 14 of the scanner 1 can be changed.

When the input section 22 is operated by the user, the entry content of the panel display name entry field F51 is changed, and the save button BB12 is selected, the browser execution section 211 determines that the input for editing the scan destination information is received.

Thereafter, the browser execution section 211 determines whether an input for editing the scan destination information 312 is received (step SA25), and when the input is not received, remains in a standby state until the input is received. When input for editing the scan destination information 312 is received, the browser execution section 211 transmits the input scan destination edit request to the mediation server apparatus 4 (step SA26). The scan destination edit request input here includes information on editing contents.

The mediation processor 400 of the mediation server apparatus 4 receives the scan destination edit request (step SB23), and transmits a request for the print access token 512 to the DB server apparatus 5 (step SB24).

The DB processor 500 of the DB server apparatus 5 receives the request for the print access token 512 (step SE21), and transmits the print access token 512 to the mediation server apparatus 4 (step SE22). The mediation processor 400 of the mediation server apparatus 4 receives the print access token 512 (step SB25), and transmits the scan destination edit request to the print server apparatus 3 using the print access token 512 (step SB26). The edit request transmitted here includes the editing content information input in step SA25. The print processor 300 of the print server apparatus 3 receives the scan destination edit request (step SD21), and executes scan destination editing (step SD22).

The print processor 300 transmits a scan destination editing success/failure signal indicating whether the editing of the scan destination succeeds or fails to the mediation server apparatus 4 (step SD23). The mediation processor 400 of the mediation server apparatus 4 receives the scan destination editing success/failure signal (step SB27). Then, the mediation processor 400 determines whether the scan destination editing success/failure signal received in step SB27 indicates that the editing of the scan destination succeeds (step SB29). When it is determined that the signal indicates that the editing of the scan destination fails, the mediation processor 400 transmits a scan destination editing failure signal to the browser execution section 211 (step SB29A).

The browser execution section 211 receives the scan destination editing failure signal (step SA27). Then, the browser execution section 211 displays, on the display section 23, a scan destination editing failure image indicating failure of editing of the scan destination (step SA29).

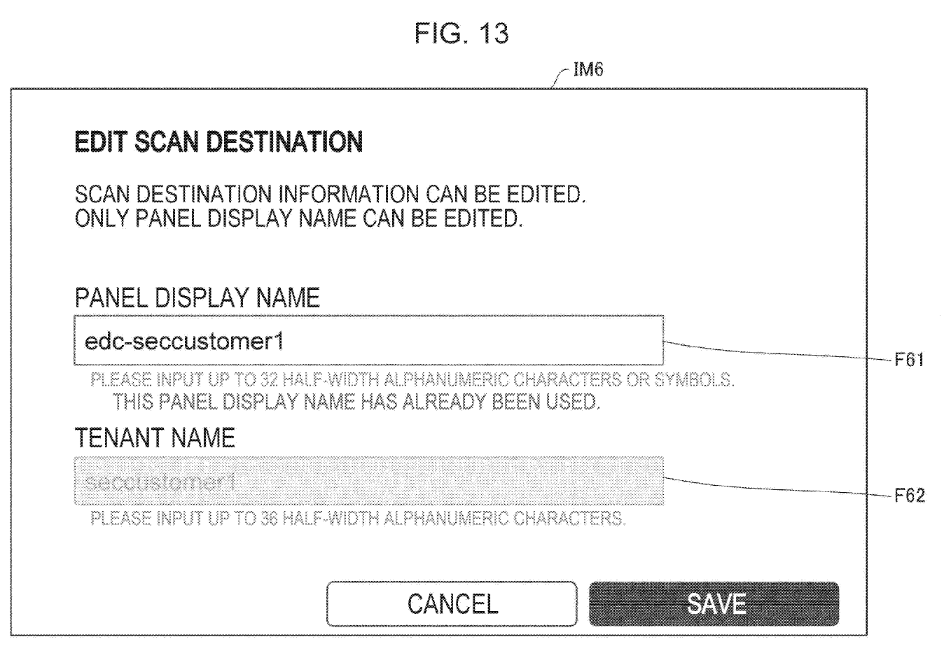

FIG. 13 is an explanatory diagram showing a display example of the display section 23 in the terminal apparatus 2. FIG. 13 shows a display example of a scan destination editing failure screen IM6. In step SA29, a scan destination editing failure screen IM6 as shown in FIG. 13 is displayed on the display section 23. Here, an example is shown in which editing of the scan destination fails due to a character string that has already been used being input in the panel display name entry field F61.

In step SB29, when it is determined that the scan destination editing success/failure signal indicates that the editing of the scan destination is successful, the mediation processor 400 transmits the scan destination information edit request to the DB server apparatus 5 (step SB30). The scan destination information edit request transmitted here includes the editing content information input in step SA25.

The DB processor 500 of the DB server apparatus 5 receives the edit request for the scan destination information 312 (step SE23). Then, the DB processor 500 edits the scan destination information associated in the destination information DB513, and transmits an edit completion notification indicating that the editing of the scan destination information 312 is completed to the mediation server apparatus 4 (step SE24).

The mediation processor 400 of the mediation server apparatus 4 receives the edit completion notification (step SB31), and transmits the edit completion notification indicating that the editing of the scan destination information 312 is completed to the terminal apparatus 2 (step SB32). The browser execution section 211 receives the edit completion notification (step SA30). The browser execution section 211 displays a scan destination editing success image indicating that editing of the scan destination succeeds on the display section 23 (step SA31). The information processing system 1000 ends the destination editing processing.

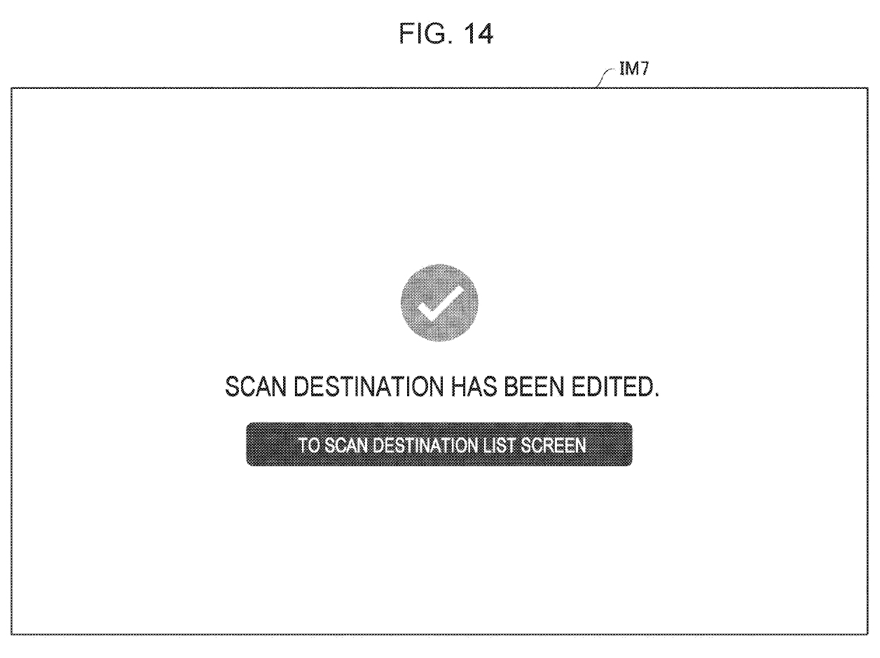

FIG. 14 is an explanatory diagram showing a display example of the display section 23 in the terminal apparatus 2. FIG. 14 shows a display example of a scan destination editing success image IM7. In step SA31, a scan destination editing success image IM7 as shown in FIG. 14 is displayed on the display section 23.

In addition, when the browser execution section 211 receives the edit completion notification in step SA30, the menu image IM1 relating to the scan destination shown in FIG. 7 may be displayed without displaying the scan destination editing success image IM7.

Step SB26 is performed by the transmission section 401 of the mediation processor 400.

Steps SB23, SB25, and SB27 are performed by the acquisition section 402 of the mediation processor 400.

Step SB30 is performed by the association section 404 of the mediation processor 400.

Steps SB29A and SB32 are performed by the notification section 405 of the mediation processor 400.

Next, an operation of the information processing system 1000 in destination deletion processing for deleting transmission destination information of the scan data registered in the print server apparatus 3 will be described.

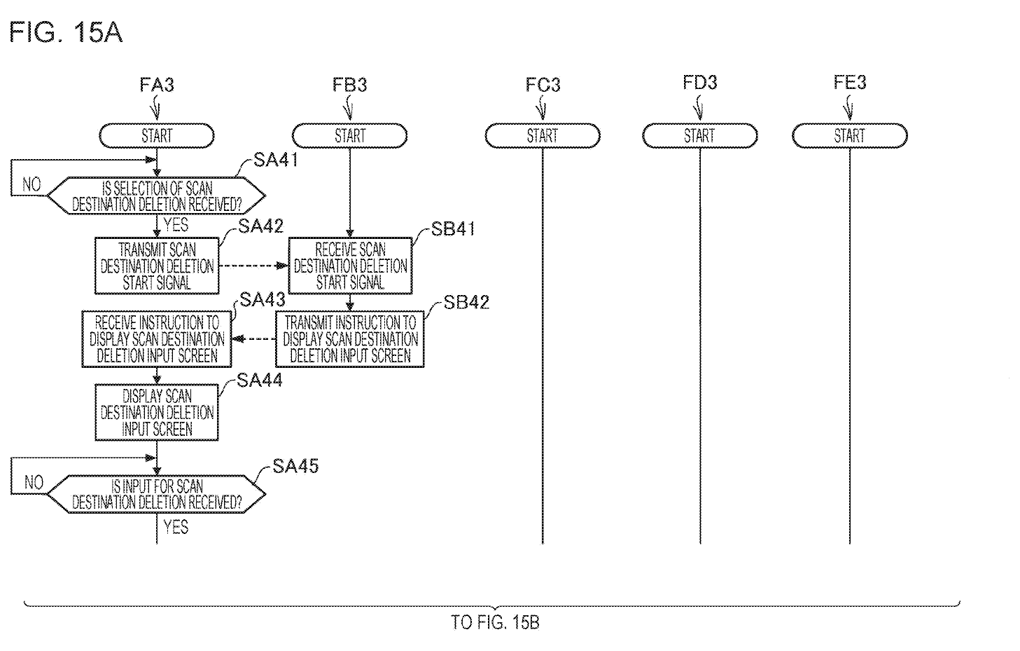

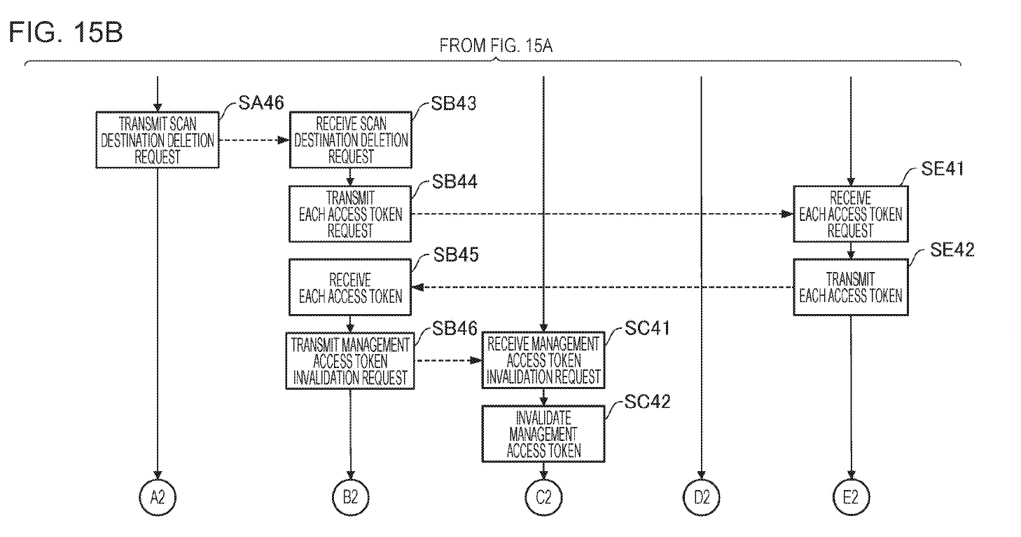

FIGS. 15A and 15B are flowcharts showing the operation of the information processing system 1000 in the destination deletion processing. In FIGS. 15A and 15B, a flowchart FA3 shows the operation of the terminal apparatus 2, and a flowchart FB3 shows the operation of the mediation server apparatus 4. A flowchart FC3 shows the operation of the management server apparatus 6, a flowchart FD3 shows the operation of the print server apparatus 3, and a flowchart FE3 shows the operation of the DB server apparatus 5.

As shown in FIG. 15A, the browser execution section 211 determines whether a deletion instruction to delete a scan destination, which is a transmission destination of scan data registered in the management server apparatus 6, is input (step SA41). If the deletion instruction is not input, the browser execution section 211 remains in a standby state until the deletion instruction is input. When the information processing system 1000 receives another instruction during the standby state, the information processing system 1000 ends the destination deletion processing and performs processing according to the received instruction.

When the deletion instruction is input, the browser execution section 211 transmits a scan destination deletion start signal indicating that the deletion instruction is input to the mediation server apparatus 4 (step SA42). The mediation processor 400 of the mediation server apparatus 4 receives the scan destination deletion start signal (step SB41), and transmits an instruction to display the scan destination deletion input screen to the terminal apparatus 2 (step SB42). The browser execution section 211 receives the instruction to display the scan destination deletion input screen (step SA43). The browser execution section 211 displays the scan destination deletion input screen (step SA44).

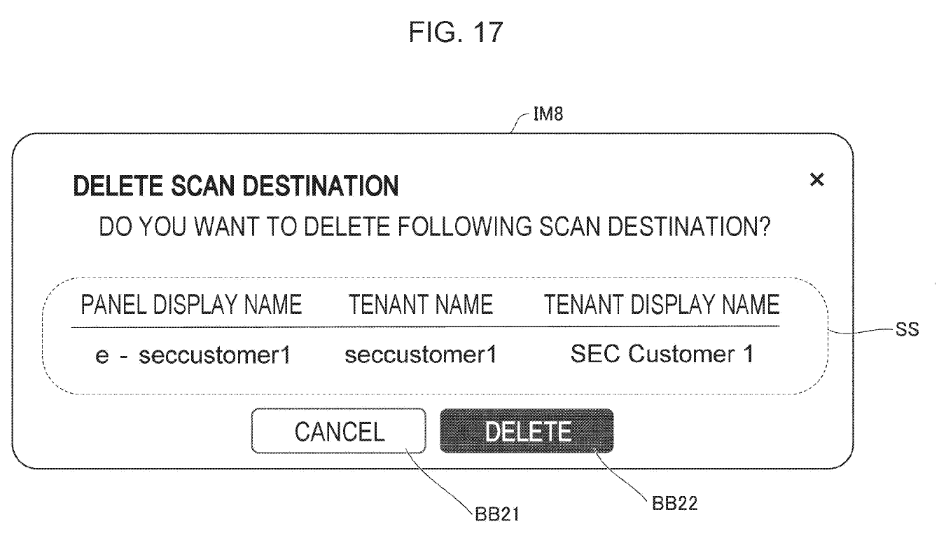

FIG. 17 is an explanatory diagram showing a display example of the display section 23 in the terminal apparatus 2. On a scan destination deletion input screen IM8 shown in FIG. 17, a scan destination display SS, a cancel button BB21, and a delete button BB22 are displayed.

When the input section 22 is operated by the user and the delete button BB22 is selected, the browser execution section 211 determines that input for deleting the scan destination information described in the scan destination display SS is received. Here, the scan destination display SS may not be displayed.

Thereafter, the browser execution section 211 determines whether the input for deleting the scan destination information is received (step SA45), and when the input is not received, remains in a standby state until the input is received. When the input of the deletion of the scan destination information is received, the browser execution section 211 transmits the input scan destination deletion request to the mediation server apparatus 4 (step SA46). The scan destination deletion request input here includes information for specifying a scan destination to be deleted.

The mediation processor 400 of the mediation server apparatus 4 receives the scan destination deletion request (step SB43), and requests the DB server apparatus 5 to transmit the print access token 512 and the management access token (step SB44).

The DB processor 500 of the DB server apparatus 5 receives the request for the print access token 512 and the management access token (step SE41). Then, the DB processor 500 transmits the print access token 512 and the management access token to the mediation server apparatus 4 (step SE42). The mediation processor 400 of the mediation server apparatus 4 receives the print access token 512 and the management access token (step SB45). The mediation processor 400 transmits an invalidation request of the management access token corresponding to the scan destination to be deleted to the management server apparatus 6 (step SB46).

The management processor 600 of the management server apparatus 6 receives the management access token invalidation request (step SC41), and invalidates the management access token (step SC42). The management processor 600 transmits an invalidation completion signal indicating that the invalidation of the management access token is completed to the mediation server apparatus 4 (step SC43).

The mediation processor 400 of the mediation server apparatus 4 receives the invalidation completion signal (step SB47), and transmits the scan destination deletion request to the print server apparatus 3 by using the print access token 512 (step SB48). The deletion request transmitted here includes the deletion content information input in step SA45. The print processor 300 of the print server apparatus 3 receives the scan destination deletion request (step SD41), and executes the scan destination deletion (step SD42).

The print processor 300 transmits a scan destination deletion success/failure signal indicating whether the deletion of the scan destination succeeds or fails to the mediation server apparatus 4 (step SD43). The mediation processor 400 of the mediation server apparatus 4 receives the scan destination deletion success/failure signal (step SB49). Then, the mediation processor 400 determines whether the scan destination deletion success/failure signal received in step SB49 indicates that the deletion of the scan destination succeeds (step SB51). When it is determined that the signal indicates that the deletion of the scan destination fails, the mediation processor 400 transmits a scan destination deletion failure signal to the browser execution section 211 (step SB51A).

The browser execution section 211 receives the scan destination deletion failure signal (step SA47). The browser execution section 211 displays the scan destination deletion failure image indicating that the deletion of the scan destination fails on the display section 23 (step SA49).

In step SB51, when it is determined that the scan destination deletion success/failure signal indicates that the deletion of the scan destination is successful, the mediation processor 400 transmits the scan destination information deletion request to the DB server apparatus 5 (step SB52). The scan destination information deletion request transmitted here includes the deletion content information input in step SA45.

The DB processor 500 of the DB server apparatus 5 receives the scan destination information deletion request (step SE43). Then, the DB processor 500 specifies scan destination information designated by the deletion request among the scan destination information associated in the destination information DB513. Then, the DB processor 500 deletes the specified scan destination information, and transmits a deletion completion notification indicating that the deletion of the scan destination information is completed to the mediation server apparatus 4 (step SE44).

The mediation processor 400 of the mediation server apparatus 4 receives the deletion completion notification (step SB53), and transmits, to the terminal apparatus 2, the scan destination deletion success notification indicating that the deletion of the scan destination information succeeds (step SB54). The terminal processor 210 of the terminal apparatus 2 receives the scan destination deletion success notification (step SA50). The browser execution section 211 displays the scan destination deletion success image indicating that the deletion of the scan destination succeeds on the display section 23 (step SA51). The information processing system 1000 ends the destination deletion processing.

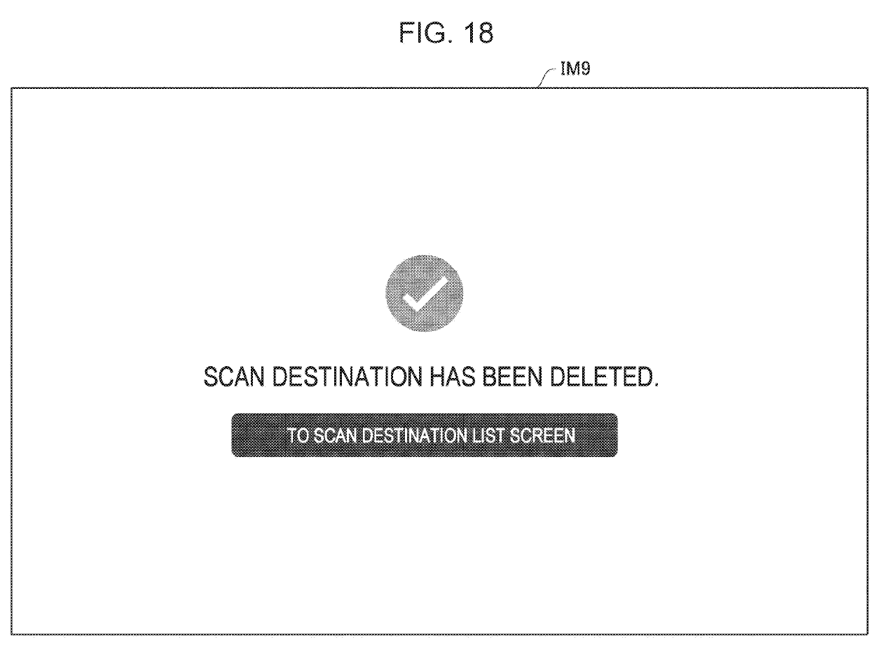

FIG. 18 is an explanatory diagram showing a display example of the display section 23 in the terminal apparatus 2. FIG. 18 shows a display example of a scan destination deletion success image IM9. In step SA50, a scan destination deletion success image IM9 as shown in FIG. 18 is displayed on the display section 23.

In addition, when the terminal processor 210 receives the scan destination deletion success notification in step SA50, the menu image IM1 relating to the scan destination shown in FIG. 7 may be displayed without displaying the scan destination deletion success image IM9.

Steps SB46 and SB48 are performed by the transmission section 401 of the mediation processor 400.

Steps SB43 and SB49 are performed by the acquisition section 402 of the mediation processor 400.

Step SB52 is performed by the association section 404 of the mediation processor 400.

Step SB51A is performed by the notification section 405 of the mediation processor 400.

Next, an operation of the information processing system 1000 in scan data registration processing for registering scan data in the management server apparatus 6 will be described.

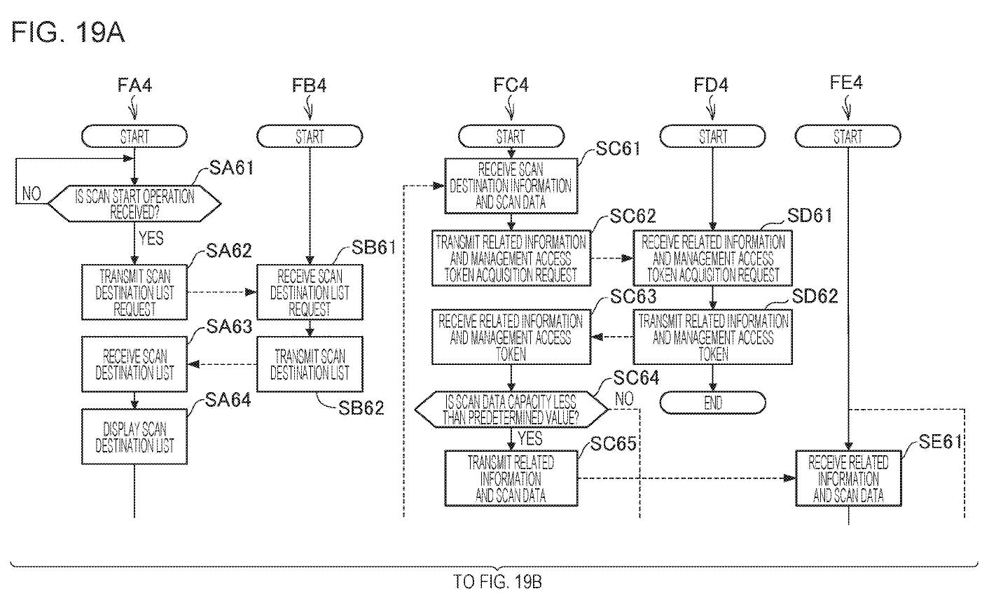

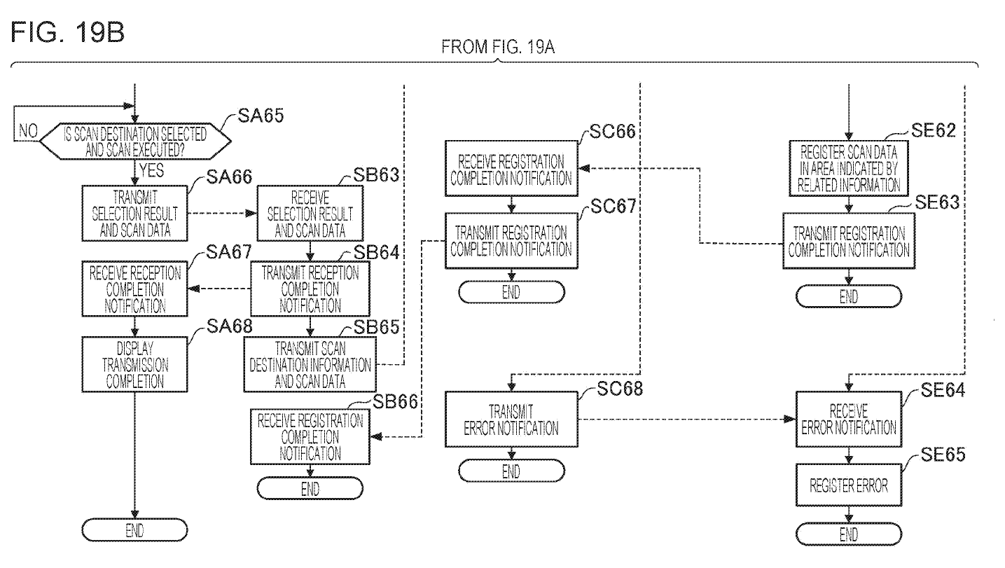

FIGS. 19A and 19B are flowcharts showing the operation of the information processing system 1000 in the scan data registration processing. In FIGS. 19A and 19B, a flowchart FA4 shows the operation of the scanner 1, and a flowchart FB4 shows the operation of the print server apparatus 3. Further, a flowchart FC4 shows the operation of the mediation server apparatus 4, a flowchart FD4 shows the operation of the DB server apparatus 5, and a flowchart FE4 shows the operation of the management server apparatus 6.

As shown in FIG. 19A, the scanner processor 100 determines whether an input indicating start of scanning is received from the user (step SA61). The scanner processor 100 transmits a scan destination list request to the print server apparatus 3 (step SA62). The print processor 300 of the print server apparatus 3 receives the scan destination list request (step SB61), and transmits the scan destination list to the scanner 1 (step SB62).

The scanner processor 100 of the scanner 1 receives the scan destination list (step SA63), and displays the scan destination list on the display section 14 (step SA64). The scanner processor 100 determines whether one scan destination is selected and scanning is performed (step SA65). The execution of scanning specifically means that the scanning section 12 reads a character or an image and outputs image data obtained by the reading to the scanner control section 10. As described above, the scan data is data read by selecting the scan destination in the management server apparatus 6.

When one scan destination is selected and scanning is performed, the scanner processor 100 transmits specific information of the scan destination which is a selection result and the scan data to the print server apparatus 3 (step SA66). The print processor 300 of the print server apparatus 3 receives the specific information of the scan destination which is a selection result and the scan data (step SB63), and transmits a reception completion notification indicating that the scan data is received to the scanner 1 (step SB64).

The scanner processor 100 of the scanner 1 receives the reception completion notification (step SA67), and displays a transmission completion screen indicating that the specific information of the scan destination and the scan data are transmitted to the print server apparatus 3 on the display section 14 (step SA68).

After step SB64, the print processor 300 transmits the scan destination information and the scan data to the mediation server apparatus 4 (step SB65). The scan destination information transmitted here is information specified by the received scan destination specific information among the scan destination information 312 stored in the print memory 310. The mediation processor 400 of the mediation server apparatus 4 receives the scan destination information 312 and the scan data (step SC61). The mediation processor 400 transmits, to the DB server apparatus 5, a request to acquire the related information and the management access token corresponding to the destination ID included in the scan destination information (step SC62).

The DB processor 500 of the DB server apparatus 5 receives the acquisition request for the related information and the management access token corresponding to the destination ID (step SD61). The DB processor 500 specifies the related information and the management access token corresponding to the destination ID and transmits them to the mediation server apparatus 4 (step SD62). As described above, the destination ID, the related information, and the management access token are stored in association with each other in the destination information DB513 of the DB processor 500.

The mediation processor 400 of the mediation server apparatus 4 receives the related information and the management access token (step SC63). The mediation processor 400 determines whether the data capacity of the scan data received in step SC61 is less than a predetermined value (step SC64). When the data capacity is less than the predetermined value, the mediation processor 400 transmits the related information and the scan data to the management server apparatus 6 (step SC65).

The management processor 600 of the management server apparatus 6 receives the related information and the scan data (step SE61), and registers the scan data in the storage area indicated by the related information in the management memory 610 (step SE62). Then, the management processor 600 transmits a registration completion notification indicating that the registration of the scan data is completed to the mediation server apparatus 4 (step SE63).

The mediation processor 400 of the mediation server apparatus 4 receives the registration completion notification (step SC66), and transmits the registration completion notification to the print server apparatus 3 (step SC67). The print processor 300 of the print server apparatus 3 receives the registration completion notification (step SB66). The information processing system 1000 ends the scan data registration processing.

When it is determined in step SC64 that the data capacity of the scan data is greater than or equal to the predetermined value, the mediation processor 400 transmits an error notification to the management server apparatus 6 (step SC68). The management processor 600 of the management server apparatus 6 receives the error notification (step SE64), and registers the error (step SE65). In this way, since the error is registered in the management server apparatus 6, the user can recognize that the scan data is not registered in the management server apparatus 6 by confirming the registration information of the management server apparatus 6 from the terminal apparatus 2, for example.

Steps SC65, SC67, and SC68 are performed by the transmission section 401 of the mediation processor 400.

Steps SC61 and SC66 are performed by the acquisition section 402 of the mediation processor 400.

Step SC64 is performed by the determination section 406 of the mediation processor 400.

### 5. Configuration and Effect

As described above, the mediation server apparatus 4 can communicate with the print server apparatus 3 that acquires the scan data and the management server apparatus 6 that registers the scan data.

The mediation server apparatus 4 includes the acquisition section 402, the generation section 403, the transmission section 401, and the association section 404.

The acquisition section 402 acquires the print access token 512 indicating the access right to the print server apparatus 3.

The acquisition section 402 acquires a management access token indicating an access right to the management server apparatus 6 from the management server apparatus 6.

The generation section 403 generates a destination ID of a transmission destination of the scan data in the management server apparatus 6.

The transmission section 401 transmits a registration instruction to register the scan destination information 312 for specifying the transmission destination of the scan data in the management server apparatus 6 to the print server apparatus 3 using the print access token 512.

The association section 404 associates a plurality of pieces of information including the management access token and the destination ID.

The scan destination information 312 is information including the destination ID.

As a result, the transmission destination of the scan data in the management server apparatus 6 can be registered in the print server apparatus 3. Therefore, it is possible to appropriately transmit the scan data to the management server apparatus 6.

The scan destination information 312 is indicated by a uniform resource locator (URL).

Accordingly, the transmission destination of the scan data can be registered in the print server apparatus 3 by using the URL.

Further, the mediation server apparatus 4 includes the notification section 405.

The acquisition section 402 acquires registration success information indicating success of registration of the scan destination information 312 from the print server apparatus 3.

The notification section 405 acquires the registration success information, and notifies the terminal apparatus 2 that the registration of the scan destination information 312 succeeds based on the completion of the association by the association section 404.

This allows the user to easily recognize that the scan data is appropriately registered in the management server apparatus 6.

The acquisition section 402 acquires an edit request for editing the scan destination information 312.

The transmission section 401 transmits an instruction to edit the scan destination information 312 to the print server apparatus 3 based on the acquisition of the edit request.

The association section 404 can execute edit control of the associated information based on the acquisition of the edit request.

As a result, the scan destination information 312 can be edited as desired by the user.

The acquisition section 402 acquires the print access token 512 based on the acquisition of the edit request.

The transmission section 401 transmits an instruction to edit the scan destination information 312 to the print server apparatus 3 by using the print access token 512 based on the acquisition of the edit request.

As a result, an instruction to edit the scan destination information 312 can be transmitted to the print server apparatus 3 by using the print access token 512.

The acquisition section 402 acquires edit failure information indicating failure in editing the scan destination information 312 from the print server apparatus 3.

When the edit failure information is acquired, the association section 404 does not perform the edit control of the associated information.

When the edit failure information is acquired, the notification section 405 notifies the terminal apparatus that editing of the scan destination information 312 fails.

As a result, the user can easily recognize the failure of the editing of the scan destination information 312.

The acquisition section 402 acquires, from the print server apparatus 3, edit success information indicating success in editing the scan destination information 312.

When the edit success information is acquired, the notification section 405 notifies the terminal apparatus that the editing of the scan destination information 312 succeeds.

As a result, the user can easily recognize the success of the editing of the scan destination information 312.

The acquisition section 402 acquires a deletion request for deleting the scan destination information 312.

The transmission section 401 transmits an instruction to delete the scan destination information 312 to the print server apparatus 3 using the print access token 512 based on the acquisition of the deletion request.

The association section 404 can execute deletion control of the associated information based on the acquisition of the deletion request.

As a result, the scan destination information 312 can be deleted as desired by the user.

The acquisition section 402 acquires deletion failure information indicating failure in deleting the scan destination information 312 from the print server apparatus 3.

When the deletion failure information is acquired, the association section 404 does not perform the deletion control of the associated information.

When the deletion failure information is acquired, the notification section 405 notifies the terminal apparatus that the deletion of the scan destination information 312 fails.

As a result, the user can easily recognize the failure of the deletion of the scan destination information 312.

The acquisition section 402 acquires deletion success information indicating success in deleting the scan destination information 312 from the print server apparatus 3.

When the deletion success information is acquired, the notification section 405 notifies the terminal apparatus that the deletion of the scan destination information 312 succeeds.

As a result, the user can easily recognize the success of the deletion of the scan destination information 312.

When the deletion request is acquired, the transmission section 401 transmits an instruction to invalidate the management access token to the management server apparatus 6.

As a result, the second access token that is no longer used can be invalidated.

In an information processing method performed by the mediation server apparatus 4, the mediation server apparatus 4 acquires a print access token indicating the access right to the print server apparatus 3. In addition, the mediation server apparatus 4 acquires the management access token indicating the access right to the management server apparatus 6 from the management server apparatus 6. Further, the mediation server apparatus 4 generates the destination ID of the transmission destination of the scan data in the management server apparatus 6. Further, the mediation server apparatus 4 uses the print access token to transmit, to the print server apparatus 3, a registration instruction to register the scan destination information 312 for specifying the transmission destination of the scan data in the management server apparatus 6. In addition, the mediation server apparatus 4 associates a plurality of pieces of information including the management access token and the destination ID. The scan destination information 312 is information including the destination ID.

Accordingly, the same effects as those of the mediation server apparatus 4 described above are achieved.

The control program 411 causes the mediation server apparatus 4 to execute processing for acquiring a print access token, processing for acquiring a management access token, and processing for generating a destination ID. Further, the control program 411 causes the mediation server apparatus 4 to execute processing for transmitting a registration instruction to register the scan destination information 312 to the print server apparatus 3 by using the print access token. In addition, the control program 411 executes processing for associating a plurality of pieces of information including the management access token and the destination ID. The scan destination information 312 is information including the destination ID.

Accordingly, the same effects as those of the mediation server apparatus 4 described above are achieved.

As described above, the mediation server apparatus 4 can communicate with the print server apparatus 3 that acquires the scan data and the management server apparatus 6 that registers the scan data.

The mediation server apparatus 4 includes the acquisition section 402 and the transmission section 401.

The acquisition section 402 acquires scan data and a destination ID of a transmission destination of the scan data in the management server apparatus 6 from the print server apparatus 3.

The acquisition section 402 acquires the related information related to the transmission destination of the scan data and the management access token indicating the access right to the management server apparatus 6 based on the destination ID acquired by the acquisition section 402.

The transmission section 401 transmits the scan data to the management server apparatus 6 using the management access token based on the related information acquired by the acquisition section 402.

As a result, the scan data can be transmitted to the management server apparatus 6 without changing the control content of the print server apparatus 3.

The related information acquired by the acquisition section 402 is associated with the management access token.

Thus, the related information and the management access token can be collectively acquired.

The scan data is data read by selecting the scan destination information 312 for specifying the transmission destination of the scan data in the management server apparatus 6.

As a result, the processing can be performed by associating the scan destination information 312 with the scan data.

The scan destination information 312 is indicated by a uniform resource locator (URL).

Accordingly, the transmission destination of the scan data can be transmitted to the print server apparatus 3 by using the URL.

The acquisition section 402 acquires the destination ID included in the URL from the print server apparatus 3.

The transmission section 401 transmits the scan data to the management server apparatus 6 based on the destination ID.

As a result, the scan data can be appropriately transmitted to the management server apparatus 6.

The acquisition section 402 acquires a registration completion notification indicating that the registration of the scan data is completed from the management server apparatus 6.

The transmission section 401 transmits the registration completion notification to the print server apparatus 3.

Accordingly, the registration completion information of the scan data can be managed by the print server apparatus 3.

Further, the mediation server apparatus 4 includes the determination section 406.

A determination section 406 determines a data capacity of the scan data.

When the data capacity determined by the determination section 406 is equal to or greater than a predetermined value, the transmission section 401 transmits an error notification to the management server apparatus 6.

As a result, the information indicating that the data capacity of the scan data is equal to or greater than the predetermined value can be managed by the management server apparatus 6.

In an information processing method performed by the mediation server apparatus 4, the mediation server apparatus 4 acquires scan data and a destination ID of a transmission destination of the scan data in the management server apparatus 6 from the print server apparatus 3. Further, based on the acquired destination ID, the mediation server apparatus 4 acquires related information related to the transmission destination of the scan data, and a management access token indicating an access right to the management server apparatus 6. Further, the mediation server apparatus 4 transmits the scan data to the management server apparatus 6 using the management access token based on the acquired related information.

Accordingly, the same effects as those of the mediation server apparatus 4 described above are achieved.

The control program 411 causes the mediation server apparatus 4 to acquire the scan data and the destination ID of the transmission destination of the scan data in the management server apparatus 6 from the print server apparatus 3. Further, the control program 411 causes the mediation server apparatus 4 to acquire the related information related to the transmission destination of the scan data and the management access token indicating the access right to the management server apparatus 6 based on the acquired destination ID. Further, the control program 411 causes the mediation server apparatus 4 to transmit the scan data to the management server apparatus 6 using the management access token based on the acquired related information.

Accordingly, the same effects as those of the mediation server apparatus 4 described above are achieved.

### 6. Other Embodiments

In the above-described embodiment, the mediation server apparatus 4 is configured to edit and delete the registered transmission destination of the scan data in the management server apparatus 6, but may be configured to update the transmission destination.

For example, in the menu image IM2 shown in FIG. 7, an update button may be displayed in addition to the add button BA1, the edit button BA2, and the delete button BA3. When the input section 22 is operated by the user and the update button is selected, the terminal processor 210 may determine that the update instruction for updating the transmission destination is input.

When the update instruction is input, for example, a display image in which both of the panel display name entry field and the tenant name entry field are changeably displayed may be displayed on the display section 23 of the terminal apparatus 2. Then, when the tenant name is changed and the save button is operated, the transmission section 401 may transmit a new storage area of the scan data to the print server apparatus 3. When the tenant name is changed and the save button is operated, the association section 404 may transmit, to the DB server apparatus 5, an instruction to update the second access token associated with the destination ID and the related information.

Further, the association section 404 may enable updating of the registered scan destination information in the destination information DB stored in the mediation server apparatus 4 when the destination information DB is stored in the mediation server apparatus 4.

In this way, the transmission section 401 may be capable of transmitting an update request for updating the transmission destination of the scan data to the print server apparatus 3. The association section 404 may associate the second access token, the destination ID, and the related information related to the transmission destination of the scan data. When the update request is transmitted by the transmission section 401, the association section 404 may update the second access token associated with the destination ID and the related information.

As a result, the scan destination information 312 can be updated as desired by the user.

The functions of the scanner processor 100, the terminal processor 210, the print processor 300, the mediation processor 400, the DB processor 500, and the management processor 600 may be realized by a plurality of processors or semiconductor chips.

The respective sections shown in FIGS. 2-4 are examples and are not particularly limited. Hardware corresponding to the respective sections individually does not necessarily need to be implemented, and a configuration in which the functions of the respective sections are realized by one processor executing a program is of course also possible. Some of the functions implemented by software may be implemented by hardware, and some of the functions implemented by hardware may be implemented by software. In addition, specific detailed configurations of other respective sections of the scanner 1, the terminal apparatus 2, the print server apparatus 3, the mediation server apparatus 4, the DB server apparatus 5, and the management server apparatus 6 can be changed as appropriate.

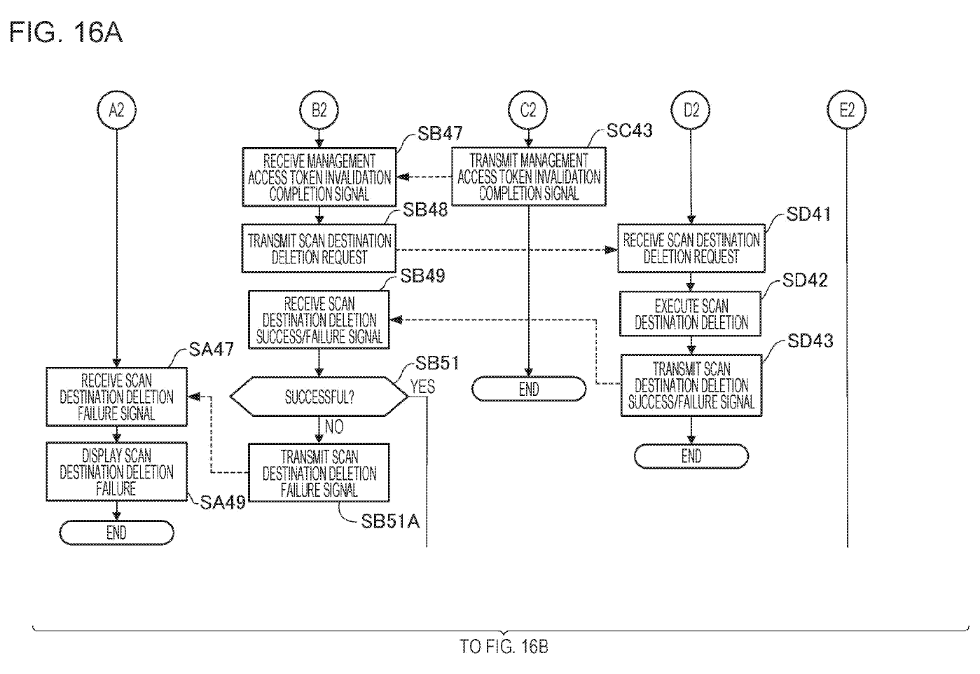

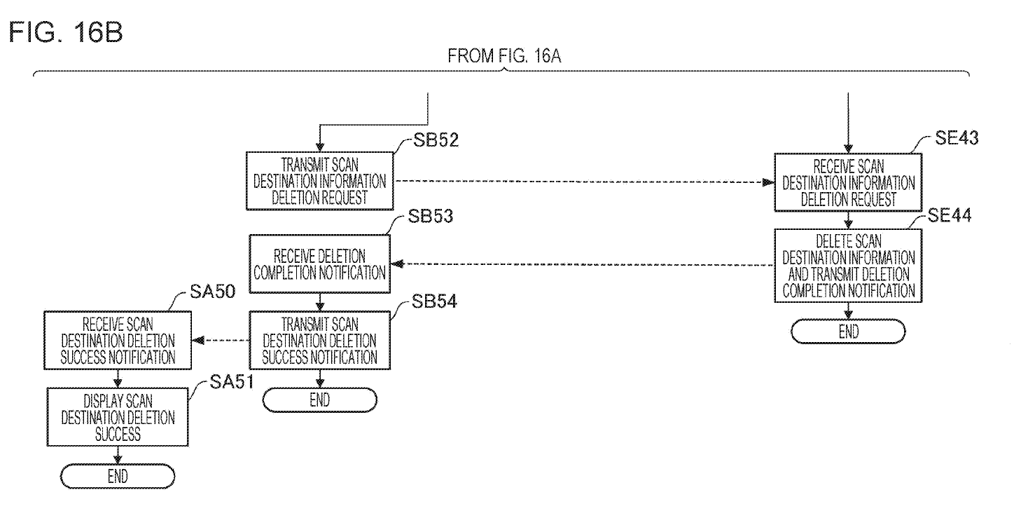

The step units of the operations shown in FIGS. 5A, 5B, 5C, 6A, 6B, 11A, 11B, 11C, 15A, 15B, 16A, 16B, 19A, and 19B are divided according to the main processing contents in order to facilitate understanding of the operations of the respective sections of the information processing system 1000, and are not limited by the method of dividing the processing units or the names. The operations may be further divided into a larger number of step units according to the processing contents. One step unit may be divided to include a large number of processing. In addition, the order of the steps may be changed as appropriate.

The scanner 1 may have other functions as long as it has at least a reading function. For example, a composite printer having a printing function may be used.

What is claimed is:

1. An information processing apparatus capable of communicating with a first server apparatus configured to acquire scan data and a second server apparatus configured to register the scan data, the information processing apparatus comprising:
a first acquisition section configured to acquire, from the first server apparatus, the scan data and identification information of a transmission destination of the scan data in the second server apparatus;
a second acquisition section configured to acquire, based on the identification information acquired by the first acquisition section, related information related to the transmission destination of the scan data and a second access token indicating an access right to the second server apparatus; and
a transmission section configured to transmit the scan data to the second server apparatus using the second access token based on the related information acquired by the second acquisition section.

2. The information processing apparatus according to claim 1, wherein
the related information and the second access token are associated with each other.

3. The information processing apparatus according to claim 1, wherein
the scan data is data read by selecting transmission destination information for specifying the transmission destination of the scan data in the second server apparatus.

4. The information processing apparatus according to claim 3, wherein
the transmission destination information is indicated by a uniform resource locator (URL).

5. The information processing apparatus according to claim 4, wherein
the first acquisition section acquires the identification information included in the URL from the first server apparatus, and
the transmission section transmits the scan data to the second server apparatus based on the identification information.

6. The information processing apparatus according to claim 1, further comprising:
a third acquisition section configured to acquire a registration completion notification indicating that the registration of the scan data is completed from the second server apparatus; and
a registration completion notification transmission section configured to transmit the registration completion notification to the first server apparatus.

7. The information processing apparatus according to claim 1, further comprising:
a determination section configured to determine a data capacity of the scan data; and
an error notification transmission section configured to transmit an error notification to the second server apparatus when the data capacity determined by the determination section is equal to or greater than a predetermined value.

8. An information processing method performed by an information processing apparatus capable of communicating with a first server apparatus configured to acquire scan data and a second server apparatus configured to register the scan data, the method comprising:
acquiring, from the first server apparatus, the scan data and identification information of a transmission destination of the scan data in the second server apparatus;
acquiring, based on the acquired identification information, related information related to the transmission destination of the scan data and a second access token indicating an access right to the second server apparatus; and
transmitting the scan data to the second server apparatus using the second access token based on the acquired related information.

9. A non-transitory computer-readable storage medium storing a program executable by an information processing apparatus capable of communicating with a first server apparatus configured to acquire scan data and a second server apparatus configured to register the scan data, the program causing the information processing apparatus to execute:
acquiring, from the first server apparatus, the scan data and identification information of a transmission destination of the scan data in the second server apparatus;
acquiring, based on the acquired identification information, related information related to the transmission destination of the scan data and a second access token indicating an access right to the second server apparatus; and
transmitting the scan data to the second server apparatus
using the second access token based on the acquired related information.
